(19) United States
(12) Patent Application Publication
(10) Pub. No.: US 2024/0236775 A9
(43) Pub. Date: Jul. 11, 2024

(54) Technique for Mobility Update Reporting

(71) Applicant: Telefonaktiebolaget LM Ericsson (publ), Stockholm (SE)

(72) Inventors: Min Wang, Luleå (SE); Zhang Fu, Stockholm (SE)

(21) Appl. No.: 18/270,661

(22) PCT Filed: Jan. 13, 2022
(86) PCT No.: PCT/EP2022/050655

§ 371 Date: Jun. 30, 2023

Related U.S. Application Data
(60) Provisional application No. 63/136,804, filed on Jan. 13, 2021.

(51) Int. Cl. H04W 36/00

(52) U.S. Cl. CPC H04W 36/0058; H04W 36/0085; H04W 92/18

(57) ABSTRACT

A technique for forwarding a mobility update report from a remote radio device (100-RM) that is in relayed radio communication with a radio access network, RAN (530), through a relay radio device (100-RL; 1100; 1391; 1392; 1430), is described. The remote radio device (100-RM) is in a first radio resource control, RRC, state (502-RM) relative to the RAN (530), and the relay radio device (100-RL; 1100; 1391; 1392; 1430) is in a second RRC state (502-RL) relative to the RAN (530), wherein the first RRC state is different from the second RRC state. As to a method aspect of the technique, the method (300-RL) performed by the relay radio device (100-RL; 1100; 1391; 1392; 1430) comprises or initiated the step of receiving (302-RL) the mobility update report from the remote radio device (100-RM) on a sidelink, SL, between the remote radio device (100-RM) and the relay radio device (100-RL; 1100; 1391; 1392; 1430), the mobility update report being indicative of a mobility update of the remote radio device (100-RM). The mobility update report is transmitted (304-RL) to the RAN (530).

### TECHNICAL FIELD

The present disclosure relates to a technique for mobility update reporting using a sidelink between radio devices. More specifically, and without limitation, methods and devices are provided for forwarding, determining and providing a mobility update report using a sidelink between radio devices.

### BACKGROUND

The Third Generation Partnership Project (3GPP) defined sidelinks (SLs) in Release 12 as an adaptation of the Long Term Evolution (LTE) radio access technology for direct communication between two radio devices, also referred to as user equipment (UE), without going through a base station. Such device-to-device (D2D) communications through SLs are also referred to as proximity service (ProSe). The D2D interface is designated as PC5. SLs can be used for Public Safety communications. While conventional public safety communications use different standards in different geographical regions and countries, 3GPP SL communications enable interworking of different public safety groups. 3GPP has enriched SLs in Release 13 for public safety and commercial communication use-cases and, in Release 14, for vehicle-to-everything (V2X) scenarios.

A relay UE can provide forwarding functionality that can relay any type of traffic over the PC5 interface, i.e. over the SL. For example, a UE-to-Network relay UE provides the functionality to support connectivity to the 5G system for remote UEs. A UE is considered to be a remote UE if it has successfully established a PC5 link or SL to the relay UE. The remote UE can be located within the coverage of a radio access network (RAN) of the 5G system or outside of RAN coverage.

To reduce power consumption, UEs can assume inactive and idle states. These states differ in terms of mobility updates provided to the RAN and further to a core network (CN) connected to the RAN. Therefore, combinations of such states for the remote UE and the relay UE can lead to incompatible reporting of mobility updates. For example, the remote UE cannot report RAN-based Notification Area Updates (RNAUs) to the RAN according to the inactive state while the relay UE is in the idle state. Furthermore, the remote UE cannot report a registration area update (RAU) to the CN while relay UE is in the inactive state.

### SUMMARY

Accordingly, there is a need for a sidelink relaying technique that enables different states of radio devices in the sidelink. An alternative or more specific object is a technique for mobility update reporting using a sidelink between radio devices.

As to a first method aspect, a method of forwarding a mobility update report from a remote radio device is provided. The remote radio device is in relayed radio communication with a radio access network (RAN) through a relay radio device. The remote radio device is in a first radio resource control (RRC) state relative to the RAN. The relay radio device is in a second RRC state relative to the RAN. The first RRC state is different from the second RRC state. The method is performed by the relay radio device. The method comprises or initiates a step of receiving the mobility update report from the remote radio device on a sidelink (SL) between the remote radio device and the relay radio device. The mobility update report is indicative of a mobility update of the remote radio device. The method further comprises or initiates a step of transmitting the mobility update report to the RAN.

The first method aspect may be implemented alone or in combination with any one of the claims in the list of claims, particularly the claims 1 to 42.

The RRC state of the remote radio device may be an RRC state relative to the RAN in that the RRC state of the remote radio device is maintained at both the remote radio device and the RAN, e.g., at a base station of the RAN serving (e.g., directly) the relay radio device and/or (e.g., indirectly) the remote radio device.

The SL may comprise a PC5 interface between the remote radio device and the relay radio device.

The RAN may comprise one or more base station, e.g., an eNodeB (eNB) or a gNodeB (gNB). Any feature referring to the RAN may be implemented by using a base station (e.g., a serving base station) of the RAN.

The first RRC state (e.g., according to the first method aspect) may not be an RRC connected state. Alternatively or in addition, the second RRC state may not be an RRC connected state. Alternatively or in addition, the transmitting of the mobility update report to the RAN may comprise initiating a random access procedure with the RAN.

For example, neither the remote radio device nor the relay radio device are in an RRC connected state relative to (i.e., with) the RAN.

The mobility update may depend on a first area configured for the remote radio device in the first RRC state. The mobility update report may be triggered by the remote radio device moving out of the first area.

The random access procedure may be initiated on behalf of the remote radio device or for the relay radio device.

The mobility update (e.g., according to the first method aspect) may be periodically reported by the remote radio device.

The mobility update report (e.g., according to the first method aspect) may be triggered by the remote radio device moving out of a first area, optionally a size of the first area depending on the first RRC state. Alternatively or in addition, a spatial granularity of the mobility update may depend on the first RRC state.

A size of the first area may be greater if the first RRC state is an RRC idle state as compared to a size of the first area if the first RRC state is an RRC inactive state.

A further mobility update report of the relay radio device may be triggered by the relay radio device moving out of a second area. A size of the second area may depend on the second RRC state. Alternatively or in addition, a granularity of the first area may be different from a granularity of the second area.

The first RRC state (e.g., according to the first method aspect) may be an RRC inactive state and the second RRC state may be an RRC idle state.

The first area may be a RAN-based notification area (RNA).

The mobility update report (e.g., according to the first method aspect) may be triggered by the remote radio device moving out of a RAN-based notification area (RNA).

The mobility update (e.g., according to the first method aspect) may comprise a RAN-based notification area update (RNAU).

The RNAU may be reported from the remote radio device only if the remote radio device is in the RRC inactive state. Alternatively or in addition, a registration area update (RAU) may be reported from the remote radio device in addition to the reporting of the RNAU if the remote radio device is in the RRC inactive state.

The mobility update report (e.g., according to the first method aspect) may comprise an RRC resume request.

The RRC resume request may be a RRCResumeRequest or RRCResumeRequest1 according to the 3GPP document TS 38.331, version 16.3.1.

The mobility update report from the remote radio device in the RRC inactive state or the mobility update report indicative of the RNAU (e.g., according to the first method aspect) may be addressed to the RAN, optionally to a base station of the RAN.

The transmitting of the mobility update report to the RAN (e.g., according to the first method aspect) may comprise initiating, by the relay radio device, a random access procedure on behalf of the remote radio device towards the RAN.

The transmitted mobility update report (e.g., according to the first method aspect) may comprise an RRC resume request that is indicative of the RNAU of the remote radio device, optionally being indicative of the RNAU as a resume cause.

The transmitted mobility update report (e.g., according to the first method aspect) may comprise at least one of an RRC resume request, a resume cause, the RRC resume request, and the resume cause being indicative of at least one of the RNAU of the remote radio device; the random access being performed by the relay radio device on behalf of the remote radio device; and an identifier of the remote radio device.

The identifier of the remote radio device may comprise a radio network temporary identifier (RNTI), e.g., a cell RNTI (C-RNTI) or an inactive RNTI (I-RNTI).

The transmitting of the mobility update report to the RAN (e.g., according to the first method aspect) may comprise at least one of initiating, by the relay radio device, a random access procedure for the relay radio device towards the RAN; and transmitting, by the relay radio device, an RRC setup request to the RAN.

The RRC setup request (e.g., according to the first method aspect) may be indicative of the relay radio device. Alternatively or in addition, the RRC setup request may be indicative of the RNAU of the remote radio device as an establishment cause.

The RRC setup request may comprise an identifier of the relay radio device such as a Temporary Mobile Subscriber Identity (TMSI), e.g., a ng-5G-S-TMSI, or a local identifier known by the RAN or the base station of the RAN.

The mobility update report transmitted by the relay radio device responsive to an RRC connected state relative to the RAN (e.g., according to the first method aspect) may comprise an RRC resume request and/or a resume cause. Optionally the RRC resume request and/or the resume cause being indicative of at least one of the RNAU of the remote radio device; and an identifier of the remote radio device.

The identifier of the remote radio device may comprise a radio network temporary identifier (RNTI), e.g., a cell RNTI (C-RNTI) or an inactive RNTI (I-RNTI).

The method (e.g., according to the first method aspect) wherein the mobility update report may be transmitted by the relay radio device as a container in the RRC setup request to the RAN.

The first RRC state (e.g., according to the first method aspect) may be an RRC idle state and the second RRC state may be an RRC inactive state.

The mobility update report (e.g., according to the first method aspect) may be triggered by the remote radio device moving out of a registration area (RA).

The RA of the remote radio device may encompass the RNA of the remote radio device. The RNA of the remote radio device may be smaller than the RA of the remote radio device.

The mobility update (e.g., according to the first method aspect) may comprise a registration area update (RAU) and/or a non-access stratum (NAS) registration request.

The mobility update report from the remote radio device may comprise only the RAU if the remote radio device is in the RRC idle state.

The mobility update report from the remote radio device in the RRC idle state or the mobility update report indicative of the RAU (e.g., according to the first method aspect) may be addressed to a CN connected to the RAN, optionally to an access and mobility management function (AMF) of the CN.

The CN may be associated with the RAN.

The transmitting (e.g., according to the first method aspect) may comprise the relay radio device waiting until a RAU of the relay radio device may be triggered and transmitting the mobility update report as a combined RAU report indicative of both the RAU of the remote radio device and the RAU of the relay radio device.

The combined RAU report (e.g., according to the first method aspect) may comprise an identifier of the relay radio device.

The remote radio device may be identified based on an association (e.g., the SL) between the relay radio device and the remote radio device. The combined RAU report may not need to comprise an identifier of the remote radio device.

The transmitting of the mobility update report to the RAN (e.g., according to the first method aspect) may comprise at least one of initiating, by the relay radio device, a random access procedure on behalf of the remote radio device towards the RAN; and transmitting, by the relay radio device, an RRC setup request on behalf of the remote radio device to the RAN.

The RRC setup request (e.g., according to the first method aspect) may be indicative of the remote radio device, and/or wherein the RRC setup request may be indicative of the RAU of the remote radio device as an establishment cause.

The RRC setup request may comprise an identifier of the remote radio device such as a Temporary Mobile Subscriber Identity (TMSI), e.g., a ng-5G-S-TMSI, or a local identifier known by the RAN or the base station of the RAN.

The method (e.g., according to the first method aspect) wherein a dedicated NAS message field in the RRC setup request may comprise at least one of the RAU of the remote radio device; and an identifier of the remote radio device.

The mobility update report (e.g., according to the first method aspect) may be transmitted by the relay radio device as a container in the RRC setup request to the RAN for forwarding the mobility update report to the CN.

The transmitting of the mobility update report to the RAN (e.g., according to the first method aspect) may comprise initiating, by the relay radio device, a random access procedure for the relay radio device towards the RAN.

The transmitted mobility update report (e.g., according to the first method aspect) may comprise an RRC resume request that is indicative of the RAU of the remote radio device, optionally being indicative of the RAU as a resume cause.

The transmitted mobility update report (e.g., according to the first method aspect) may comprise an RRC resume request and/or a resume cause, the RRC resume request and/or the resume cause being indicative of at least one of the RAU of the remote radio device; the random access being performed by the relay radio device on behalf of the remote radio device; and an identifier of the remote radio device.

The identifier of the remote radio device may comprise a radio network temporary identifier (RNTI), e.g., a cell RNTI (C-RNTI) or an inactive RNTI (I-RNTI).

The mobility update report (e.g., according to the first method aspect) may be transmitted by the relay radio device responsive to an RRC connected state relative to the RAN.

The mobility update report (e.g., according to the first method aspect) may be received in at least one of a container of the SL; RRC signaling; a medium access control (MAC) control element (CE); and a control protocol data unit (PDU) of a protocol layer of the SL or an adaptation layer of the relayed radio communication.

The mobility update report may be received in a container using the PC5 interface and/or a PC5-RLC layer or PC5-RRC layer of the SL. For example, the container may be a PC5-RLC protocol data unit (PDU), a PC5-RRC PDU, a PC5-RLC service data unit (SDU), or a or PC5-RRC SDU.

The mobility update of the remote radio device (e.g., according to the first method aspect) may be triggered by measuring at least one of a camped cell of the remote radio device, one or more serving cells of the remote radio device, one or more neighbor cells of the remote radio device, a camped cell of the relay radio device, one or more serving cells of the relay radio device, and one or more neighbor cells of the relay radio device.

The measurement of at least one cell (e.g., according to the first method aspect) may be performed by the remote radio device, optionally wherein a result of the measurement is received on the SL from the remote radio device.

Out of the cells measured by the remote radio device, the result of the measurement of the at least one cell that relates to the relay radio device are received from the remote radio device.

The measurement of at least one cell (e.g., according to the first method aspect) may be performed by the relay radio device, optionally wherein a result of the measurement may be transmitted on the SL to the remote radio device.

Out of the cells measured by the relay radio device, the result of the measurement of the at least one cell that relates to the remote radio device are transmitted to the remote radio device.

Optionally, the measurement may be exclusively performed by the relay radio device. For example, no measurement may be performed by the remote radio device. The remote radio device may relay on the result of the measurement received from the relay radio device.

The measurement (e.g., according to the first method aspect) may be received or transmitted on the SL in at least one of a container of the SL; RRC signaling; a medium access control (MAC) control element (CE); and a control protocol data unit (PDU) of a protocol layer of the SL or an adaptation layer of the relayed radio communication.

The mobility update report (e.g., according to the first method aspect) may be indicative of at least one of the RNAU or RAU of the remote radio device; an identifier of the remote radio device; an early measurement report of the remote radio device; a buffer status report of the remote radio device; a power status report of the remote radio device; and a power headroom report of the remote radio device.

Yet as to a first method aspect, a method of determining a mobility update report on behalf of a remote radio device that is in relayed radio communication with a radio access network (RAN), through a relay radio device, the remote radio device being in a first radio resource control (RRC) state relative to the RAN and the relay radio device being in a second RRC state relative to the RAN is provided. The first RRC state is different from the second RRC state. The method performed by the relay radio device comprises or initiates the step of determining the mobility update report on behalf of the remote radio device based on a result of a measurement of at least one cell shared on a sidelink (SL) between the remote radio device and the relay radio device, the mobility update report being indicative of a mobility update of the remote radio device. The method further comprises or initiates the step of transmitting the mobility update report to the RAN.

The method (e.g., according to the first method aspect) further comprises the features or steps according to any one of claims 1 to 40.

Yet as to a first method aspect, a method of providing a mobility update report from a remote radio device that is in relayed radio communication with a radio access network (RAN), through a relay radio device, the remote radio device being in a first radio resource control (RRC) state relative to the RAN and the relay radio device being in a second RRC state relative to the RAN, wherein the first RRC state is different from the second RRC state is provided. The method performed by the remote radio device comprises or initiates the step of transmitting the mobility update report from the remote radio device on a sidelink (SL) between the remote radio device and the relay radio device, the mobility update report being indicative of a mobility update of the remote radio device. The method further comprises or initiates the step of receiving, on the SL, a response from the RAN in response to the relay radio device transmitting the mobility update report to the RAN.

The method (e.g., according to the first method aspect) may further comprise the features or steps of any one of claims 2 to 42 or any feature or step corresponding thereto.

As to another aspect, a computer program product comprising program code portions for performing the steps of any one of the claims 1 to 40, 41 to 42, or 43 to 44 when the computer program product is executed on one or more computing devices is provided. Optionally stored on a computer-readable recording medium.

As to a first device aspect, a relay radio device comprising memory operable to store instructions and processing circuitry operable to execute the instructions is provided. The relay radio device is operable to receive a mobility update report from a remote radio device on a sidelink (SL) between the remote radio device and the relay radio device, the mobility update report being indicative of a mobility update of the remote radio device; and transmit the mobility update report to a RAN.

The radio device (e.g., according to the first device aspect) further operable to perform the steps of any one of claims 2 to 42.

Yet as to a first device aspect, a relay radio device for forwarding a mobility update report from a remote radio device that is in relayed radio communication with a radio access network (RAN), through the relay radio device, the remote radio device being in a first radio resource control (RRC) state relative to the RAN and the relay radio device being in a second RRC state relative to the RAN, wherein the first RRC state is different from the second RRC state is provided. The relay radio device being configured to receive the mobility update report from the remote radio device on a sidelink (SL) between the remote radio device and the relay radio device, the mobility update report being indicative of a mobility update of the remote radio device; and transmit the mobility update report to the RAN.

The relay radio device (e.g., according to the first device aspect) may further be configured to perform the steps of any one of claims 2 to 42.

Yet as to a first device aspect a relay user equipment (UE) configured to communicate with a base station or with a further relay UE is provided. The relay UE comprising a radio interface and processing circuitry configured to receive a mobility update report from a remote UE on a sidelink (SL) between the remote UE and the relay UE, the mobility update report being indicative of a mobility update of the remote UE; and transmit the mobility update report to a RAN.

The relay UE (e.g., according to the first device aspect) wherein the processing circuitry may be further configured to execute the steps of any one of claims 2 to 42.

As to a second device aspect, a remote radio device comprising memory operable to store instructions and processing circuitry operable to execute the instructions is provided. The remote radio device is operable to transmit a mobility update report from the remote radio device on a sidelink (SL) between the remote radio device and a relay radio device, the mobility update report being indicative of a mobility update of the remote radio device. The remote radio device is further operable to receive, on the SL, a response from the RAN in response to the relay radio device transmitting the mobility update report to the RAN.

The remote device (e.g., according to the second device aspect) may be further operable to perform the steps or comprise the features of the first device or method aspect, or a step or feature corresponding thereto.

Yet as to a second device aspect, a remote radio device for providing a mobility update report from the remote radio device that is in relayed radio communication with a radio access network (RAN), through a relay radio device, the remote radio device being in a first radio resource control (RRC) state relative to the RAN and the relay radio device being in a second RRC state relative to the RAN, wherein the first RRC state is different from the second RRC state is provided.

The remote radio device is configured to transmit the mobility update report from the remote radio device on a sidelink (SL) between the remote radio device and the relay radio device, the mobility update report being indicative of a mobility update of the remote radio device. The remote radio device is further configured to receive, on the SL, a response from the RAN in response to the relay radio device transmitting the mobility update report to the RAN.

The remote radio device (e.g., according to the second device aspect) may be further configured to perform the steps or comprise the features of the first device or method aspect, or a step or feature corresponding thereto.

Yet as to a second device aspect, a remote user equipment (UE) configured to communicate with a base station or with a relay UE is provided. The remote UE comprising a radio interface and processing circuitry configured to transmit a mobility update report from the remote radio device on a sidelink (SL) between the remote radio device and a relay radio device, the mobility update report being indicative of a mobility update of the remote radio device. The remote UE further configured to receive, on the SL, a response from the RAN in response to the relay radio device transmitting the mobility update report to the RAN.

The processing circuitry may be further configured to execute the steps or comprises the features of the first device or method aspect, or a step or feature corresponding thereto.

As to a further device aspect, a communication system including a host computer is provided. The communication system comprising processing circuitry configured to provide user data; and a communication interface configured to forward user data to a cellular or ad hoc radio network for transmission to a user equipment (UE) wherein the UE comprises a radio interface and processing circuitry, the processing circuitry of the UE being configured to execute the steps of any one of the first, second and/or third aspects.

The communication system (e.g., according to the further device aspect) may further include the UE.

The radio network may further comprise a base station, which may be configured to communicate with the UE.

The processing circuitry of the host computer may be configured to execute a host application, thereby providing the user data; and the processing circuitry of the UE may be configured to execute a client application associated with the host application.

As to an alternative first method aspect, a method of determining a mobility update report on behalf of a remote radio device is provided. The remote radio device is in relayed radio communication with a radio access network (RAN) through a relay radio device. The remote radio device is in a first radio resource control (RRC) state relative to the RAN. The relay radio device is in a second RRC state relative to the RAN. The first RRC state is different from the second RRC state. The method is performed by the relay radio device. The method comprises or initiates a step of determining the mobility update report on behalf of the remote radio device based on a result of a measurement of (e.g., in) at least one cell. The result of the measurement is shared (e.g., transmitted and/or received) on a sidelink (SL) between the remote radio device and the relay radio device. The mobility update report is indicative of a mobility update of the remote radio device. The method further comprises or initiates a step of transmitting the mobility update report to the RAN.

The alternative first method aspect may be implemented alone or in combination with any one of the claims in the list of claims, particularly the claims 41 to 44.

The alternative first method aspect may further comprise any feature or step disclosed in the context of the first method aspect, particularly the claims 1 to 40, and vice versa.

As to a second method aspect, a method of providing a mobility update report from a remote radio device is provided. The remote radio device is in relayed radio communication with a radio access network (RAN) through a relay radio device.

The remote radio device is in a first radio resource control (RRC) state relative to the RAN. The relay radio device is in a second RRC state relative to the RAN. The first RRC state is different from the second RRC state. The method is performed by the remote radio device. The method comprises or initiates a step of transmitting the mobility update report from the remote radio device on a sidelink (SL) between the remote radio device and the relay radio device. The mobility update report is indicative of a mobility update of the remote radio device. The method further comprises or initiates a step of receiving, on the SL, a response from the RAN in response to the relay radio device transmitting the mobility update report to the RAN.

The second method aspect may be implemented alone or in combination with any one of the claims in the list of claims, particularly the claims 43 to 44.

The second method aspect may further comprise any feature and/or any step disclosed in the context of the first method aspect or the alternative first method aspect, or a feature and/or step corresponding thereto, e.g., a receiver counterpart to a transmitter feature or step.

A third method aspect relates to a method of receiving a mobility update report at a base station of the RAN. The third method aspect may comprise any feature and/or any step disclosed in the context of the first method aspect or the alternative first method aspect or the second method aspect, or a feature and/or step corresponding thereto, e.g., a receiver counterpart to a transmitter feature or step.

The third method aspect may be performed by the base station (e.g., a gNB or eNB) serving the relay radio device.

Any aspect of the technique may be implemented in a baseband, a radio, an ASIC, an antenna, memory, I/O ports, and/or a processor of the respective relay radio device, remote radio device or base station.

Any aspect of the technique may be implemented as a method of a updating a RAN-based notification area (RNA, i.e., performing an RNA update) and/or updating a registration area (RA, i.e., performing an registration RA update) in case of a sidelink (SL) relay. The RNA may also be referred to as a “RAN notification area”. The RNA update may be abbreviated by RNAU or may be referred to as a RNAU procedure. The RA update may be abbreviated by RAU or may be referred to as a RAU procedure.

Examples of the mobility update include the RNAU and the RAU. Examples of the RRC states include RRC inactive (also denoted RRC_INACTIVE) and RRC idle (also denoted: RRC_IDLE).

The remote radio device may be in relayed radio communication with the RAN (e.g., only) through the relay radio device by means of the SL.

Without limitation, for example in a 3GPP implementation, any “radio device” may be a user equipment (UE).

The technique may be implemented to support one or more combinations of the RRC states for the remote UE and the relay UE, i.e., at least one combination of different RRC states for the remote UE and the relay UE. For example, the at least one combination of RRC states may comprise one or more combinations discussed in the 3GPP meeting RAN2 #112-e.

Alternatively or in addition, the at least on combination may comprise, e.g. for L2 UE-to-Network relay UE (i.e., a SL through a relay UE), a combination of the RRC states of the remote UE being in RRC_IDLE and the relay UE being in RRC_INACTIVE. Alternatively or in addition, the at least one combination may comprise a combination of RRC states, wherein the remote UE is in RRC_INACTIVE and the relay UE is in RRC_IDLE.

Herein, a combination of RRC states is also referred to as RRC state combination.

With the RRC state combinations including, e.g.,
(1) the remote UE being in RRC_IDLE and the relay UE being in RRC_INACTIVE,
(2) the remote UE being in RRC_INACTIVE and the relay UE being in RRC_IDLE, The remote UE and the relay UE may perform mobility update reporting in different granularities. For example, the one of the UEs that is in RRC_INACTIVE may (e.g., mainly) report RAN-based notification area update (RNAU) to the RAN (e.g., a gNB), while the other one (e.g., the remote UE) of the UEs moves within its registration area. In addition, the UE may also trigger registration area update towards the core network (e.g., AMF) when the UE moves out its registration area.

While for a UE in RRC_IDLE, the UE mainly triggers registration area update (RAU) towards the core network (e.g., AMF).

At least some method claims of any method aspect may change (e.g., temporarily) the RRC state of the relay radio device and/or the remote radio device for the transmitting of the mobility update report to the RAN (e.g., to a base station and/or for further forwarding the mobility update report to the CN).

The technique may be applied in the context of 3GPP New Radio (NR). The technique may be implemented in accordance with a 3GPP specification, e.g., for 3GPP release 16 or 17. The technique may be implemented for 3GPP LTE or 3GPP NR according to a modification of the 3GPP document TS 23.303, version 16.0.0 or for 3GPP NR according to a modification of the 3GPP document TS 33.303, version 16.0.0.

The technique may be compatible with, or may extend, the technique specified in at least one of the following 3GPP documents: TS 38.321, version 16.3.0; TS 38.331, version; TS 36.331, version 16.3.1; TS 36.321, version 16.3.0; TS 38.300, version 16.4.0; and TS 36.300, version 16.4.0.

In any radio access technology (RAT), the technique may be implemented for reporting mobility updates using a SL relay. The SL may be implemented using proximity services (ProSe), e.g. according to a 3GPP specification.

Any radio device may be a user equipment (UE), e.g., according to a 3GPP specification. The relay radio device may also be referred to as a relay UE (or briefly: relay). Alternatively or in addition, the remote radio device may also be referred to as a remote UE. Alternatively or in addition, any further radio device may also be a further UE.

The relay radio device and the RAN may be wirelessly connected in an uplink (UL) and/or a downlink (DL) through a Uu interface. Alternatively or in addition, the SL may enable a direct radio communication between proximal radio devices, e.g., the remote radio device and the relay radio device, optionally using a PC5 interface. Services provided using the SL or the PC5 interface may be referred to as proximity services (ProSe). Any radio device (e.g., the remote radio device and/or the relay radio device and/or the further radio device) supporting a SL may be referred to as ProSe-enabled radio device.

The relay radio device may also be referred to as UE-to-Network Relay, SL UE-to-Network Relay, or ProSe UE-to-Network Relay.

The remote radio device and/or the relay radio device and/or the RAN and/or the further remote radio device may form, or may be part of, a radio network, e.g., according to the Third Generation Partnership Project (3GPP) or according to the standard family IEEE 802.11 (Wi-Fi). The first method aspect, the second method aspect and third method aspect may be performed by one or more claims of the remote radio device, the relay radio device and the RAN (e.g., a base station) or the further remote radio device, respectively.

The RAN may comprise one or more base stations, e.g., performing the third method aspect. Alternatively or in addition, the radio network may be a vehicular, ad hoc and/or mesh network comprising two or more radio devices, e.g., acting as the remote radio device and/or the relay radio device and/or the further remote radio device.

Any of the radio devices may be a 3GPP user equipment (UE) or a Wi-Fi station (STA). The radio device may be a mobile or portable station, a device for machine-type communication (MTC), a device for narrowband Internet of Things (NB-loT) or a combination thereof. Examples for the UE and the mobile station include a mobile phone, a tablet computer and a self-driving vehicle. Examples for the portable station include a laptop computer and a television set. Examples for the MTC device or the NB-loT device include robots, sensors and/or actuators, e.g., in manufacturing, automotive communication and home automation. The MTC device or the NB-loT device may be implemented in a manufacturing plant, household appliances and consumer electronics.

Whenever referring to the RAN, the RAN may be implemented by one or more base stations.

The remote radio device may be wirelessly connected or connectable (e.g., according to a radio resource control, RRC, state or active mode) with the relay radio device and, optionally, at least one base station of the RAN. The relay radio device may be wirelessly connected or connectable (e.g., according to a radio resource control, RRC, state or active mode) with at least one base station of the RAN and/or a further remote radio device. Furthermore, the relay radio device may be wirelessly connected or connectable on the SL (e.g., according to 3GPP ProSe) with the remote radio device.

Herein, a base station may encompass any station that is configured to provide radio access to any of the radio devices. The base stations may also be referred to as cell, transmission and reception point (TRP), radio access node or access point (AP). The base station and/or the relay radio device may provide a data link to a host computer providing the user data to the remote radio device or gathering user data from the remote radio device. Examples for the base stations may include a 3G base station or Node B, 4G base station or eNodeB, a 5G base station or gNodeB, a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a packet data convergence protocol (PDCP) layer, and/or a Radio Resource Control (RRC) layer of a protocol stack for the radio communication.

As to another aspect, a computer program product is provided. The computer program product comprises program code portions for performing any one of the steps of the any of the method aspects disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

Moreover, device aspects according to the claims 42, 44, 46, 48, 50 and 52 are provided. For example, a first device aspect, an alternative first device aspect, a second device aspect, and a third device aspect may relate to devices configured to perform the first method aspect, the alternative first method aspect, the second method aspect, and the third method aspect, respectively.

The device aspects may comprise any feature and/or any step disclosed in the context of the respective method aspect or a feature and/or step corresponding thereto, e.g., a receiver counterpart to a transmitter feature or step.

As to a still further aspect a communication system including a host computer is provided. The host computer comprises a processing circuitry configured to provide user data, e.g., included in the first and/or second data of the multi-layer transmission. The host computer further comprises a communication interface configured to forward the first and/or second data to a cellular network (e.g., the RAN and/or the base station) for transmission to a UE. The (e.g., remote and/or relay) UE comprises a radio interface and processing circuitry, which is configured to execute any one of the steps of the first method aspect, the alternative first method aspect, and/or the second method aspect.

The communication system may further include the (e.g., remote and/or relay) UE. Alternatively, or in addition, the cellular network may further include the RAN, e.g., one or more base stations configured for radio communication with the UE and/or to provide a data link between the UE and the host computer using the first and/or second method aspects.

The processing circuitry of the host computer may be configured to execute a host application, thereby providing the data to be transmitted on the SL and/or any host computer functionality described herein. Alternatively, or in addition, the processing circuitry of the (e.g., remote and/or relay) UE may be configured to execute a client application associated with the host application.

Any one of the devices, the remote UE, the relay UE, the base station, the RAN, the core network, the communication system or any node or station for embodying the technique may further include any feature disclosed in the context of the method aspects, and vice versa. Particularly, any one of the units and modules disclosed herein may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1 shows a schematic block diagram of an embodiment of a device for forwarding a mobility update report;

FIG. 2 shows a schematic block diagram of an embodiment of a device for providing a mobility update report;

FIG. 3 shows a flowchart for an embodiment of a method of forwarding a mobility update report, which method may be implementable by the device of FIG. 1;

FIG. 4 shows a flowchart for an embodiment of a method of providing a mobility update report, which method may be implementable by the device of FIG. 2;

FIG. 5 schematically illustrates a first example of a signaling diagram for reporting an RNA update;

FIG. 6 schematically illustrates a second example of a signaling diagram for reporting an RNA update;

FIG. 7 schematically illustrates a third example of a signaling diagram for reporting an RNA update;

FIG. 8 schematically illustrates an example of a protocol stack in a user plane for SL relaying;

FIG. 9A schematically illustrates an example of a protocol stack in a control plane for SL relaying with emphasis on an embodiment of the remote radio device:

FIG. 9B schematically illustrates an example of a protocol stack in a control plane for SL relaying with emphasis on an embodiment of the remote radio device;

FIG. 10 schematically illustrates an example of a signaling diagram for a connection establishment a SL relay;

FIG. 11 shows a schematic block diagram of a relay radio device embodying the device of FIG. 1;

FIG. 12 shows a schematic block diagram of a remote radio device embodying the device of FIG. 2;

FIG. 13 schematically illustrates an example telecommunication network connected via an intermediate network to a host computer;

FIG. 14 shows a generalized block diagram of a host computer communicating via a base station or radio device functioning as a gateway with a user equipment over a partially wireless connection; and

FIGS. 15 and 16 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access RECTIFIED SHEET (RULE 91) ISA/EP technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

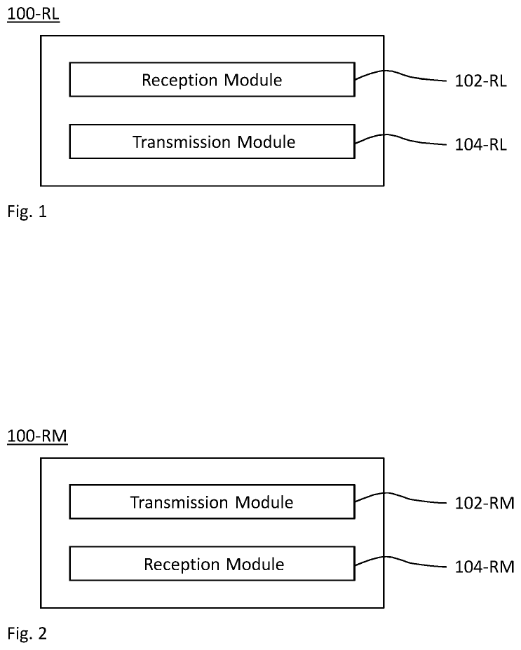

FIG. 1 schematically illustrates a block diagram of an embodiment of a device for forwarding a mobility update report from a remote radio device. The device is generically referred to by reference sign 100-RL.

The remote radio device is in relayed radio communication with a radio access network (RAN) through the relay radio device 100-RL. The remote radio device is in a first radio resource control (RRC) state relative to the RAN while the relay radio device 100-RL is in a second RRC state relative to the RAN, wherein the first RRC state is different from the second RRC state.

The relay radio device 100-RL comprises a reception module 102-RL that receives the mobility update report from the remote radio device on a SL between the remote radio device and the relay radio device. The mobility update report is indicative of a mobility update of the remote radio device.

The relay radio device 100-RL further comprises a transmission module 104-RL that transmits the mobility update report to the RAN.

Any of the modules of the device 100-RL may be implemented by units configured to provide the corresponding functionality.

The device 100-RL may also be referred to as, or may be embodied by, the relay radio device (or briefly: relay UE). The relay radio device 100-RL and the remote radio device may be in direct radio communication using the SL, e.g., at least for the receiving of the mobility update report and/or for receiving or transmitting measurement results. The remote radio device may be embodied by the device 100-RM.

FIG. 2 schematically illustrates a block diagram of an embodiment of a device for providing a mobility update report from a remote radio device. The device is generically referred to by reference sign 100-RM.

The remote radio device 100-RM is in relayed radio communication with a radio access network (RAN) through the relay radio device. The remote radio device 100-RM is in a first RRC state relative to the RAN while the relay radio device is in a second RRC state relative to the RAN, wherein the first RRC state is different from the second RRC state.

The relay radio device 100-RM comprises a transmission module 102-RM that transmits the mobility update report from the remote radio device 100-RM on a SL between the remote radio device 100-RM and the relay radio device. The mobility update report is indicative of a mobility update of the remote radio device 100-RM.

The remote radio device 100-RM further comprises a reception module 104-RM that receives, on the SL, a response from the RAN in response to the relay radio device transmitting (e.g., forwarding) the mobility update report to the RAN.

Any of the modules of the device 100-RM may be implemented by units configured to provide the corresponding functionality.

The device 100-RM may also be referred to as, or may be embodied by, the remote radio device (or briefly: remote UE). The relay radio device and the remote radio device 100-RM may be in direct radio communication using the SL, e.g., at least for the transmitting of the mobility update report and/or for receiving or transmitting measurement results. The relay radio device may be embodied by the device 100-RL.

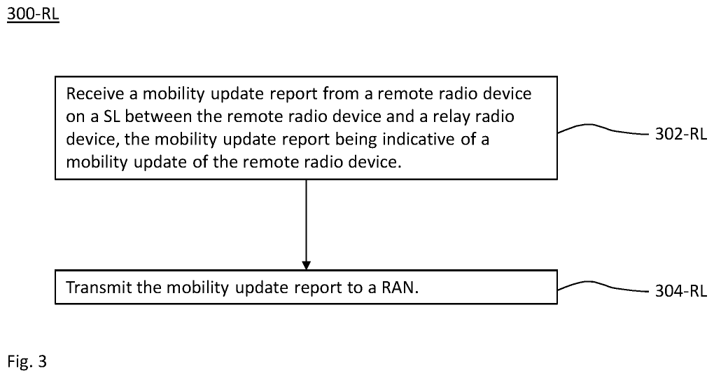

FIG. 3 shows an example flowchart for a method 300-RL of forwarding a mobility update report from a remote radio device that is in relayed radio communication with a RAN through a relay radio device. The remote radio device is in a first RRC state relative to the RAN and the relay radio device is in a second RRC state relative to the RAN. The first RRC state is different from the second RRC state.

The method 300-RL is performed by the relay radio device and comprises or initiates a step 302-RL of receiving the mobility update report from the remote radio device on a SL between the remote radio device and the relay radio device. The mobility update report is indicative of a mobility update of the remote radio device. The method 300-RL further comprises or initiates a step 304-RL of transmitting the mobility update report to the RAN.

The method 300-RL may be performed by the device 100-RL. For example, the modules 102-RL and 104-RL may perform the steps 302-RL and 304-RL, respectively.

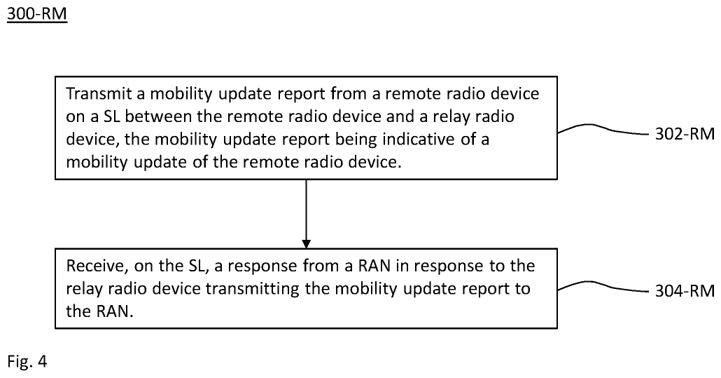

FIG. 4 shows an example flowchart for a method 300-RM of providing a mobility update report from a remote radio device that is in relayed radio communication with a RAN through a relay radio device. The remote radio device is in a first RRC state relative to the RAN and the relay radio device is in a second RRC state relative to the RAN. The first RRC state is different from the second RRC state.

The method 300-RM is performed by the remote radio device and comprises or initiates a step 302-RM of transmitting the mobility update report from the remote radio device to the relay radio device on a SL between the remote radio device and the relay radio device. The mobility update report is indicative of a mobility update of the remote radio device. The method 300-RM further comprises or initiates a step 304-RM of receiving at the remote radio device from the relay radio device, on the SL, a response from the RAN in response to the relay radio device having transmitted the mobility update report to the RAN.

The method 300-RM may be performed by the device 100-RM. For example, the modules 102-RM and 104-RM may perform the steps 302-RM and 304-RM, respectively.

In any aspect, each of the radio devices 100-RM and 10-RL may be a user equipment. The RAN may be implemented by one or more base stations.

Herein, any radio device may be a mobile or portable station and/or any radio device wirelessly connectable to a base station or RAN, or to another radio device.

For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via the SL.

Furthermore, any base station may be a station providing radio access, may be part of the radio access network (RAN) and/or may be a node connected to the RAN for controlling the radio access. For example, the base station may be an access point, for example a Wi-Fi access point.

With the two RRC state combinations, i.e.,
(1) the remote UE 100-RM being in the RRC state RRC_IDLE and the relay UE 100-RL being in the RRC state RRC_INACTIVE, and/or
(2) the remote UE 100-RM being in the RRC state RRC_INACTIVE and the relay UE 100-RL being in the RRC state RRC_IDLE, the remote UE and the relay UE can perform mobility update reporting with different (e.g., spatial and/or temporal) granularities.

For a UE in RRC_INACTIVE, the UE may report RAN-based notification area update (RNAU) to the gNB (as the RAN) while remote UE moves within its registration area (RA). In addition, any of the UEs 100-RM and 100-RL may trigger (i.e., report) registration area update (RAU) towards the core network (e.g., AMF) when the respective UE moves out its registration area. For a UE in RRC_IDLE, the UE mainly triggers registration area update (RAU) towards the core network (e.g., AMF).

Various embodiments of the methods 30-RM and 300-RL on how the relay UE 100-RL performs mobility update reporting on behalf of the remote UE 100-RM are disclosed.

In case remote UE is in RRC_INACTIVE, and relay UE is in RRC_IDLE, if the remote UE has triggered a RNAU procedure (i.e., when the remote UE moves to a cell that does not belong to the configured RNA or the remote UE has triggered a periodical RNAU procedure), the remote UE first sends the RNAU signaling (i.e., Uu RRC Resume Request) to the relay UE via the PC5 link. It can be transmitted from the remote UE to the relay UE in a container using the PC5 RRC. After reception of the RNAU signaling, the relay UE may apply at least one of the below options to forward the RNAU signaling to the gNB.

Option 1: initiate a random access (also referred to as random access procedure or random access channel, RACH, procedure) on behalf of the remote UE towards the gNB. The random access may be a 2-step random access or 4-step random access.

Since the remote UE is in RRC_INACTIVE, the relay UE transmits RRCResumeRequest or RRCResumeRequest1 with “rna-Update” as the ResumeCause to the gNB. Alternatively, a new resume cause may be introduced accordingly i.e., RNA update for the remote UE and RACH is performed by the relay UE on behalf of the remote UE. In addition, a remote UE ID (e.g., C-RNTI or I-RNTI or any remote UE IDs known the gNB) is used in the RRCResumeRequest or RRCResumeRequest1.

The RRCResumeRequest message may be an RRC message defined according to, or extended based on, the 3GPP document TS 38.331, version 16.3.1, and/or the following Abstract Syntax Notation One (ASN.1).

| -- ASN1START | |
|---|---|
| -- TAG-RRCRESUMEREQUEST-START | |
| RRCResumeRequest ::= | SEQUENCE { |
| rrcResumeRequest | RRCResumeRequest-IEs |
| } | |
| RRCResumeRequest-IEs ::= | SEQUENCE { |
| resumeIdentity | ShortI-RNTI-Value, |
| resumeMAC-I | BIT STRING (SIZE (16)), |
| resumeCause | ResumeCause, |
| spare | BIT STRING (SIZE (1)) |

}
-- TAG-RRCRESUMEREQUEST-STOP
-- ASN1STOP

The RRCResumeRequest1 message may be an RRC message defined according to, or extended based on, the 3GPP document TS 38.331, version 16.3.1, and/or the following Abstract Syntax Notation One (ASN.1).

-- ASN1START
-- TAG-RRCRESUMEREQUEST1-START

| | |
|---|---|
| RRCResumeRequest1 ::= | SEQUENCE { |
| rrcResumeRequest1 | RRCResumeRequest1-IEs |

}

| | |
|---|---|
| RRCResumeRequest1-IEs ::= | SEQUENCE { |
| resumeIdentity | I-RNTI-Value, |
| resumeMAC-I | BIT STRING (SIZE (16)), |
| resumeCause | ResumeCause, |
| spare | BIT STRING (SIZE (1)) |

}
-- TAG-RRCRESUMEREQUEST1-STOP
-- ASN1STOP

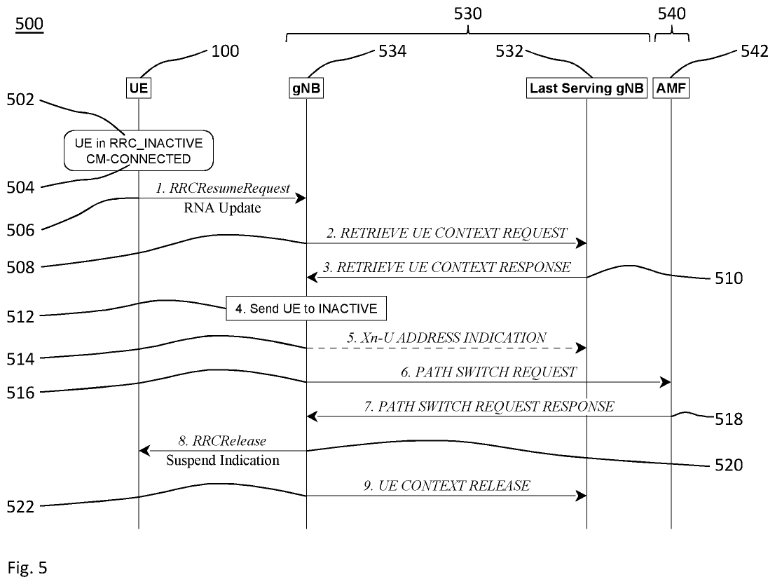

Upon reception of the RNAU signaling, the gNB handles the remote UE's context as if the remote UE has connected to the gNB directly without via the relay UE. For example, the RAN (i.e., the one or more gNBs) acts as described in the context of any one of the FIGS. 5 to 7.

After the above procedure, the remote UE will continuously stay at RRC INACTIVE or go to the other state (e.g., RRC CONNECTED or RRC IDLE) instructed by the gNB. The relay UE remains at RRC IDLE while performing the above procedure.

Option 2: initiate a random access procedure (either 2-step random access or 4-step random access) for the relay UE itself towards the gNB.

Since the relay UE is in RRC IDLE, the relay UE transmits RRCSetupRequest to the gNB as if the random access procedure has been triggered by itself. In the RRCSetupRequest message, the relay UE selects an existing EstablishmentCause e.g., “mo-Signalling”. Alternatively, a new cause may be introduced accordingly i.e., RNA update for the remote UE. In addition, the RRCSetupRequest message carries the relay UE ID (e.g., ng-5G-S-TMSI or any local ID known to the gNB).

After this RACH procedure has completed, the relay UE goes to RRC CONNECTED state. Thereafter, the relay UE directly sends the RNAU signaling (i.e., RRCResumeRequest or RRCResumeRequest1) to the gNB. Alternatively, the RNAU signaling (i.e., RRCResumeRequest or RRCResumeRequest1) is transmitted as a container in the RRCSetupRequest to the gNB.

For either of the two alternatives, the signaling message carries at least one of the following information elements. A first information element comprises a remote UE ID (e.g., C-RNTI or I-RNTI). A second information element comprises or is indicative of a purpose of the signaling, e.g., RNA update for the remote UE. A third information element comprises at least one other measurement report if it is applicable such as early measurement report, buffer status report, power headroom report, etc.

Upon reception of the RNAU signaling, the gNB handles the remote UE's context as if the remote UE has connected to the gNB directly without via the relay UE (i.e., the gNB acts the procedures, e.g. as described for the RNAU with reference to FIGS. 5 to 7).

After transmission of the RNAU signaling, the relay UE may switch to RRC INACTIVE or RRC IDLE instructed by the gNB. In order to assist the gNB's decision, the relay UE may provide additional information including one of the following indicators. A first indicator is indicative of whether the relay UE 100-RL has more data or signaling for further transmissions. A second indicator is indicative of whether the relay UE prefers to stay at RRC CONNECTED or go to other RRC state such as RRC IDLE or RRC INACTIVE.

After the above procedure, the remote UE may continuously stay at RRC_INACTIVE or go to the other state (e.g., RRC CONNECTED or RRC IDLE), e.g., as instructed by the RAN (e.g., a gNB).

Each of the remote UE and the relay UE may implement at least one of the following signaling features.

For the UE to communicate with a 5G core network (5GC), as the UE is switched-on or was in an idle state for some time and the 5GC temporarily removed resources to transfer data, the UE needs to establish a connection to the Access Management Function (AMF), which connection establishment is known as Connection Management (CM). The CM is used to establish and release the control plane signaling connection between the UE and the AMF.

The CM may represent a status of the UE with respect to its signaling with AMF in the 5GC. The CM may be used to transfer signaling messages of the non-access stratum (NAS) layer. A signaling connection between the UE and the AMF may be based on an N1 logical interface. The signaling connection between the UE and the AMF may be a combination of RRC signaling between UE and gNB, and N2-AP signaling between gNB and AMF.

The 3GPP document TS 23.501, version 16.7.0 and the 3GPP document TS 23.502, version 16.7.0 define (e.g., with respect to the signaling connection between the UE and the AMF) CM-Idle as a state of the CM and CM-Connected as another state of the CM. The CM-Idle state and CM-Connected state are maintained on the NAS layer at both the UE and the AMF.

The radio access network (RAN) of the 5G system (5GS) includes an inactive state of the radio resource control (RRC) protocol, which is also called “RRC_INACTIVE”.

In this state, radio resources are released but the context of the UE remains on the last serving gNB of the UE. If the last serving gNB receives downlink data from the UPF of the 5GC, or signaling from the AMF, the last serving gNB sends a paging message in cells of the RAN corresponding to the RAN-based Notification Area (RNA). This can include sending a paging message to one or more neighboring gNBs, which belong to the RNA, across an Xn interface.

Whilst in the RRC_INACTIVE state, the UE performs a RNA update procedure if it moves to a cell which is not part of the current RNA assigned.

For example, according to 3GPP document TS 38.304, version 16.3.4, clause 4, the RRC_INACTIVE state tasks (as well as the RRC_IDLE state tasks) can be subdivided into three processes including, firstly, PLMN selection (for UE not operating in SNPN access mode) or SNPN selection (for UE operating in SNPN access mode); secondly, cell selection and reselection; and, thirdly, location registration and RNA update.

If the UE finds a more suitable cell, according to cell reselection criteria, the UE reselects onto the respective cell and camps on that cell. If the reselected cell does not belong to at least one tracking area to which the UE is registered, location registration is performed.

In RRC_INACTIVE state, if the reselected cell does not belong to a configured RNA, a RNA update procedure for the RNA update is performed.

According to 3GPP document TS 38.304, version 16.3.4, clause 5.5 (“RAN Area registration”), the UE performs a RAN-based notification area update (RNAU) periodically or when the UE selects a cell that does not belong to the configured RNA.

Any embodiment may implement the RNAU as an example of the mobility update as described below.

The UE 100 may perform an RNA update when in an inactive state relative to the RAN 530 (e.g., a state RRC_INACTIVE, generically referred to by reference sign 502) and/or in a connected state relative to the CN 540 (e.g., a state CM-CONNECTED, generically referred to by reference sign 504). The inactive state relative to the RAN 530 may be a state relative to a serving base station (briefly: base station). For concreteness and without limitation, the base station may be an eNB or a gNB. The connected state relative to the CN 540 may be a state relative to a Mobility Manager of the CN 540. For concreteness and without limitation, the Mobility Manager may be a Mobility Management Entity (MME) or an Access and Mobility Management Function (AMF).

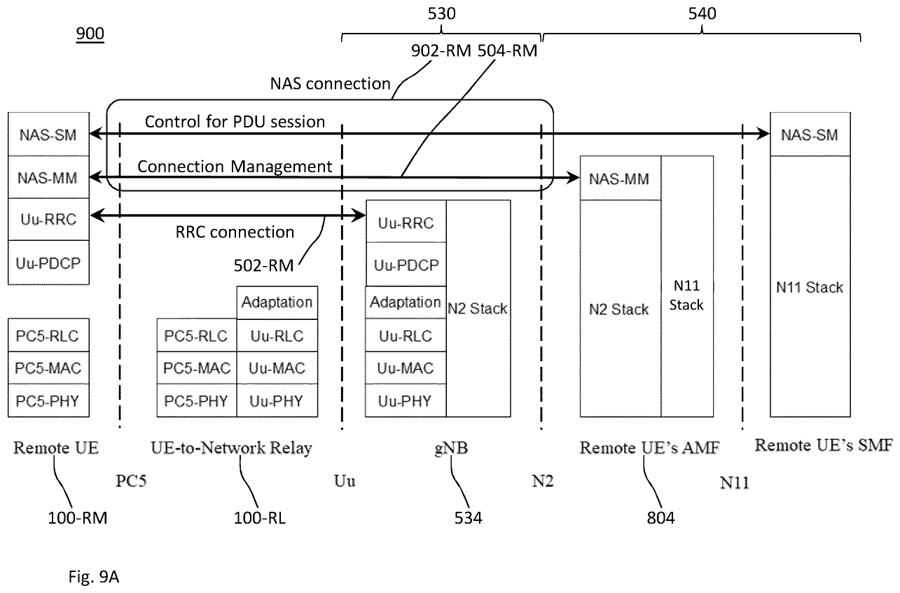

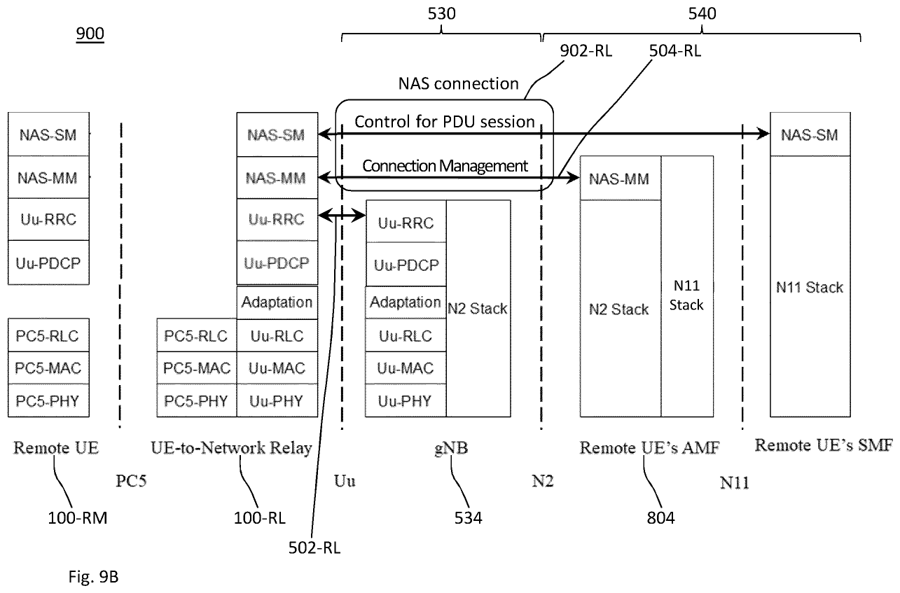

FIG. 5 shows a signaling diagram 500 for a UE-triggered RNA update (RNAU) procedure involving context retrieval over Xn, e.g., according to clause 9.2.2.5 of the 3GPP document TS 38.300, version 16.4.0. The RNAU procedure may be triggered when the UE moves out of a configured RNA, or periodically. The RNAU procedure may be implemented according to clause 9.2.2.5 or FIG. 9.2.2.5-1 of the 3GPP document TS 38.300, version 16.4.0. The RNAU procedure may cause a relocation of the UE context of the UE 100. Alternatively or in addition, the RNAU procedure may comprise at least one of the following steps.

In a step 506, the UE 100 may resume from the state RRC_INACTIVE 502 by providing the Inactive Radio Network Temporary Identifier (I-RNTI) allocated by the last serving gNB 532 of the UE 100 and an appropriate cause value, e.g., for the RNAU.

In a step 508, the gNB 534 of the UE 100, if able to resolve the identity of the last serving gNB 532 contained in the I-RNTI, may request the last serving gNB 532 to provide UE context of the UE 100, e.g., by providing the cause value received in step 506.

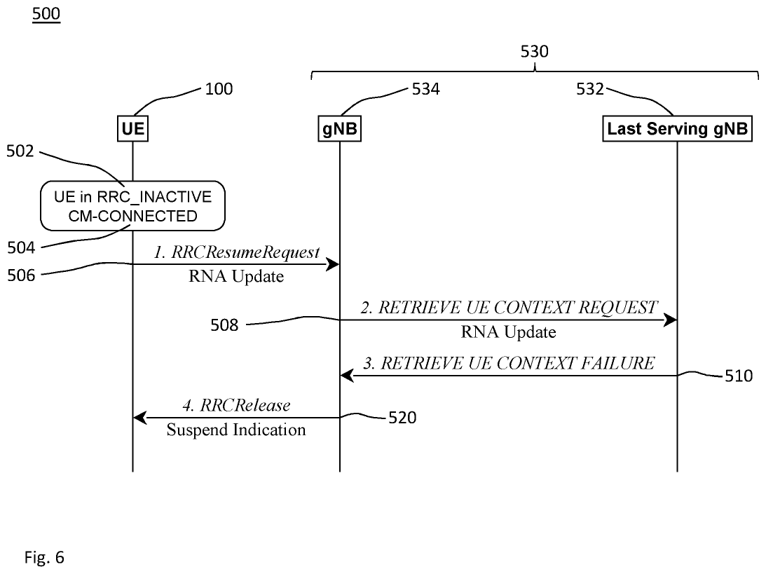

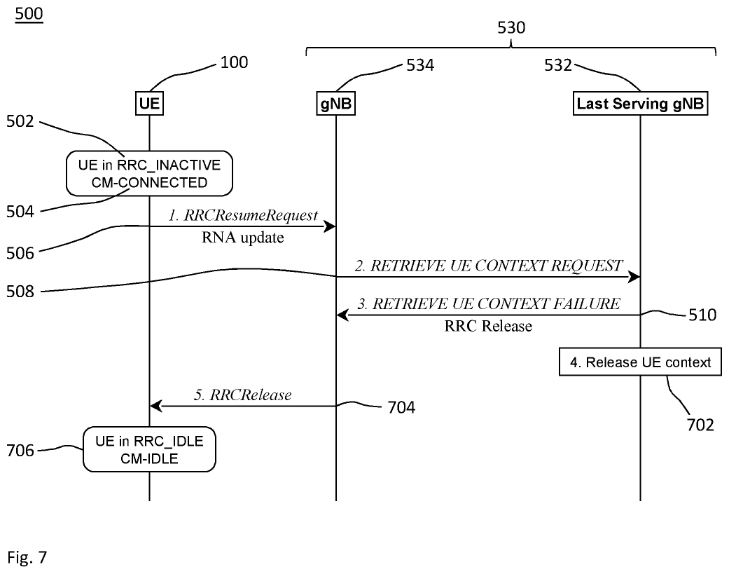

In a step 510, the last serving gNB 532 may provide the UE context of the UE 100 (as assumed in the following). Alternatively, the last serving gNB 100 may decide to move the UE 100 to the state RRC_IDLE (and the procedure follows steps 510 and later of FIG. 7 or FIG. 9.2.2.5-3 of 3GPP document TS 38.300, version 16.4.0) or, if the UE 100 is still within the previously configured RNA, to keep the UE context in the last serving gNB 532 and to keep the UE 100 in the state RRC_INACTIVE 502 (and the procedure follows steps 510 and later of FIG. 6 or FIG. 9.2.2.5-2 of 3GPP document TS 38.300, version 16.4.0).

In a step 512, the gNB 534 may move the UE 100 to RRC_CONNECTED (and the procedure follows step 512 of FIG. 9.2.2.4.1-1), or send the UE 100 back to RRC_IDLE (in which case an RRCRelease message is sent by the gNB 534 in the step 520), or send the UE 100 back to RRC_INACTIVE 502 in a step 512 as assumed in the following.

In a step 514, if loss of DL user data buffered in the last serving gNB 532 shall be prevented, the gNB 534 may provide forwarding addresses.

In step 516 and 518, the gNB 534 of the UE 100 performs path switch.

In a step 520, the gNB 534 may keep the UE 100 in the RRC_INACTIVE state 502 by sending RRCRelease with suspend indication.

In a step 522, the gNB 534 may trigger the release of the resources of the UE 100 at the last serving gNB 532.

FIG. 6 schematically illustrates a signaling diagram 500 resulting from an embodiment of the RNAU procedure for the case when the UE 100 is still within the configured RNA and/or the last serving gNB 532 decides not to relocate the UE context and to keep the UE 100 in the state RRC_INACTIVE 502. The RNAU procedure may be a periodic RNAU procedure without relocation of the UE context, e.g., according to FIG. 9.2.2.5-2 in the 3GPP document TS 38.300, version 16.4.0. Alternatively or in addition, the RNAU procedure may comprise at least one of the following steps.

In a step 506, the UE 100 may resume from RRC_INACTIVE 502 by providing the I-RNTI allocated by the last serving gNB 532 and by providing an appropriate cause value, e.g., RAN notification area update (RNAU).

In a step 508, the gNB 100 may, if able to resolve the identity of the gNB 532 contained in the I-RNTI, request the last serving gNB 532 to provide UE context of the UE 100, e.g., by providing the cause value received in the step 506.

In a step 510, the last serving gNB 532 may store received information to be used in the next resume attempt, e.g., a cell RNTI (C-RNTI) and a physical cell identity (PCI) related to the resumption cell (e.g., reselected cell). The last serving gNB 534 may further respond to the gNB 534 with the RETRIEVE UE CONTEXT FAILURE message including an encapsulated RRCRelease message. The RRCRelease message may include a Suspend Indication.

In a step 520, the gNB 532 may forward the RRCRelease message to the UE 100.

FIG. 7 shows a schematic signaling diagram resulting from an embodiment of the RNAU procedure for the case when the last serving gNB 532 decides to move the UE 100 to the state RRC_IDLE. The RNAU procedure may cause a transition to RRC_IDLE, e.g., according to FIG. 9.2.2.5-3 in 3GPP document TS 38.300, version 16.4.0. Alternatively or in addition, the RNAU procedure may comprise at least one of the following steps.

In a step 506, the UE 100 may resume from the state RRC_INACTIVE 502, e.g., by providing the I-RNTI allocated by the last serving gNB 532 and/or an appropriate cause value, e.g., the cause value of the RNAU.

In a step 508, the gNB 534 of the UE 100 may request the last serving gNB 532 to provide the UE context of the UE 100 by providing the cause value received in the step 506, if the gNB 534 is able to resolve the gNB identity of the last serving gNB 532, which is contained in the I-RNTI.

In a step 510, instead of providing the UE context of the UE 100, the last serving gNB 532 provides an RRCRelease message to move the UE 100 to RRC_IDLE (i.e., the UE 100 is triggered to assume the state RRC_IDLE).

In a step 702, the last serving gNB 534 deletes the UE context of the UE 100.

In a step 704, the gNB 534 may send the RRCRelease, which triggers the UE 100 to move to the state RRC_IDLE 706 relative to the RAN 530 (which may cause or imply that the UE 100 is in the state CM-IDLE relative to the CN 540).

The technique may be implemented for sidelink (SL) in Long Term Evolution (LTE) or 5G New Radio (NR), i.e., in a 5G System (5GS) comprising a NR RAN 530. For example, SL transmissions over 5G NR (or briefly: NR) are specified by 3GPP for Release 16. The technique may use at least one of the following four enhancements of the SL transmissions for NR.

A first enhancement, as an alternative or in addition to broadcasting, comprises unicasting and groupcasting in sidelink transmissions. For unicast and groupcast, a physical sidelink feedback channel (PSFCH) may be used by a receiving UE (e.g., the remote UE or the relay UE) to reply a decoding status to a transmitting UE (e.g., the relay UE or the remote UE, respectively).

A second enhancement comprises grant-free transmissions (e.g., as adopted in NR uplink transmissions) in NR sidelink transmissions. The second enhancement 30 may improve latency performance.

A third enhancement comprises channel sensing and/or resource selection, e.g., using an adopted design of a physical SL control channel (PSCCH). The third enhancement may alleviate resource collisions among different SL transmissions launched by different UEs (e.g., including the relay UE or the remote UE).

A fourth enhancement comprises congestion control, e.g., based on a Quality of Service (QoS) management, in NR sidelink transmissions. The fourth enhancement may increase a connection density.

To enable one or more of the above enhancements, at least one of the following physical channels and/or reference signals may be using by the SL (e.g., by a NR SL or an LTE SL).

A physical SL shared channel (PSSCH), e.g., a SL version of the physical downlink shared channel (PDSCH), is transmitted by a SL transmitting UE and/or received by a SL receiving UE. The PSSCH may convey at least one of SL transmission data, system information blocks (SIBs) for radio resource control (RRC) configuration, and a part of SL control information (SCI).

A physical SL feedback channel (PSFCH), e.g., a SL version of the physical uplink control channel (PUCCH), is transmitted by a SL receiving UE and/or received by a SL transmitting UE for unicast and/or groupcast. The PSFCH may convey 1 bit information over 1 RB for the HARQ acknowledgement (ACK) and the negative ACK (NACK).

In addition, channel state information (CSI) may be carried in the medium access control (MAC) control element (CE) over the PSSCH instead of the PSFCH.

A physical SL common control channel (PSCCH), e.g., a SL version of the physical downlink control channel (PDCCH) may be used when traffic to be transmitted to a receiving UE arrives at a transmitting UE, the transmitting UE should first transmit the PSCCH. The PSCCH may convey a part of the sidelink control information (SCI), e.g., a SL version of downlink control information (DCI), to be decoded by any UE for the channel sensing purpose. The SCI may be indicative of at least one of reserved time-frequency resources for transmissions, demodulation reference signal (DMRS) pattern, and antenna port.

The SL transmission may comprise a SL primary synchronization signal (SPSS) and/or a SL secondary synchronization signal (SSSS), e.g., similar to downlink transmissions (e.g., in LTE or NR) comprising primary and secondary synchronization signals, respectively. By detecting the SPSS and SSSS, a UE is able to identify a SL synchronization identity (SSID) of the UE transmitting the SPSS and/or the SSSS. By detecting the SPSS and/or SSSS, a UE may be therefore able to know the characteristics of the UE transmitting the SPSS and/or the SSSS. A series of process of acquiring timing and/or frequency synchronization together with SSIDs of UEs may be called initial cell search. The UE transmitting the SPSS and/or the SSSS may be or need not to be involved in the SL transmissions. A node (e.g., a UE, a eNB, or a gNB) transmitting the SPSS and/or the SSSS may b called a synchronization source.

A physical SL broadcast channel (PSBCH) may be transmitted along with the the SPSS and/or the SSSS as a synchronization signal block (SSB). The SSB has the same numerology as the PSCCH and/or the PSSCH on that carrier. The SSB should be transmitted within the bandwidth of the configured bandwidth part (BWP).

The PSBCH may convey information related to synchronization, e.g. at least one of a direct frame number (DFN), an indication of the slot and symbol level time resources for SL transmissions, and an in-coverage indicator. The SSB may be transmitted periodically at every 160 ms.

Any of the above enhancements may us physical reference signals, e.g., at least one of a demodulation reference signal (DM-RS), a phase tracking reference signal (PT-RS), and a channel state information reference signal (CSI-RS). These physical reference signals supported by NR downlink and/or uplink transmissions may also adopted by SL transmissions. Similarly, the PT-RS is only applicable for SL transmissions in the frequency range FR2 or equal to or greater than 24.250 GHz.

The SCI may be a two-stage SCI. This may be a version of the DCI for SL. Unlike the DCI, only a part (i.e., a first stage) of the SCI is transmitted on the PSCCH. The first stage is used for channel sensing, e.g., including at least one of the reserved time-frequency resources for transmissions, demodulation reference signal (DM-RS) pattern, and antenna port. The first stage may be received by all UEs. The remaining part (i.e., a second stage) is transmitted on the PSSCH to be decoded by the receiving UE (e.g., only). The second stage may comprise at least one of scheduling information and/or control information (e.g., as a 8-bits source identity and a 16-bits destination identity, respectively); a new data indicator (NDI); a redundancy version (RV); and HARQ process ID.

Similar as for proximity services (PRoSE) in LTE, SL transmissions in NR may use the following two modes of resource allocations. In Mode 1, the resources (e.g., radio resources, e.g., time-frequency resources) for the SL (i.e., for the SL transmission and/or SL reception) are scheduled by a gNB. In Mode 2, the UE autonomously selects the resources for the SL from one or more configured (e.g., preconfigured) SL resource pools, e.g., based on the channel sensing.

For an in-coverage UE (e.g., the relay UE), a gNB can be configured to adopt (e.g., use) Mode 1 or Mode 2. For an out-of-coverage UE (e.g., the remote UE), only Mode 2 can be adopted (e.g., used).

Scheduling over the SL may be performed in different ways for Mode 1 and Mode 2, (e.g., in LTE and/or in LTE).

Mode 1 may be implemented using at least one of a dynamic grant and a configured grant.

For the dynamic grant, when the traffic to be transmitted over the SL arrives at a transmitting UE, the transmitting UE may launch a four-message exchange procedure to request SL resources from a gNB, e.g., a scheduling request (SR) on uplink, a grant, a buffer status report (BSR) on uplink, a grant for data on the SL transmitted to the UE. During the resource request procedure, a gNB may allocate a SL radio network temporary identifier (SL-RNTI) to the transmitting UE (e.g., during a random access). If the SL resource request is granted by a gNB, the gNB indicates the resource allocation for the PSCCH and the PSSCH in the downlink control information (DCI) conveyed by the PDCCH with a cyclic redundancy check (CRC) scrambled with the SL-RNTI.

For the dynamic grant, when a transmitting UE receives a DCI with scrambled CRC, a transmitting UE may obtain the grant only if the scrambled CRC of the DCI matches the SL-RNTI assigned to the transmitting UE. The transmitting UE then indicates the time-frequency resources and the transmission scheme of the allocated PSSCH in the PSCCH, and launches the PSCCH and the PSSCH on the allocated resources for SL transmissions. When a grant is obtained from a gNB, the transmitting UE can only transmit a single transport block (TB). As a result, this kind of grant is suitable for traffic with no latency requirement or a relatively low latency requirement or a loose latency requirement.

For the traffic with a latency requirement or relatively high latency requirement or a strict latency requirement, performing the four-message exchange procedure to request sidelink resources may induce unacceptable latency.

For the configured grant, prior to the arrival of the traffic, a transmitting UE may perform the four-message exchange procedure and request a set of resources. If a grant can be obtained from a gNB, then the requested resources are reserved (e.g., allocated to the transmitting UE) in a periodic manner (e.g., periodically). Upon traffic arriving at a transmitting UE, this UE may transmit the PSCCH and the PSSCH on the upcoming resource occasion. The configured grant may also be referred to as a grant-free transmission.

In both dynamic grant and configured grant, a UE receiving the SL cannot receive the DCI (since it is addressed to the transmitting UE). Therefore, the receiving UE should perform blind decoding to identify the presence of PSCCH and find the resources for the PSSCH through the SCI.

The SCI may comprise a first part (i.e., first stage) and second part (i.e., second stage). The first part (e.g., on PSCCH) may contain, or may be indicative of, reserved time-frequency resources for SL transmissions, a demodulation reference signal (DMRS) pattern, and an antenna port. The second part (e.g., on PSSCH) may contain, or may be indicative of, an 8-bits source identity (ID) and a 16-bits destination ID. The SCI (e.g., the second stage) may further include a 1-bit new data indicator (NDI), a 2-bit redundancy version (RV), and 4-bit HARQ process ID.

When a transmitting UE launches the PSCCH, a CRC may be inserted (e.g., included) in the SCI, e.g., without scrambling of the CRC.

In the Mode 2 of the resource allocation, when traffic arrives at a transmitting UE, the transmitting UE may autonomously select resources for the PSCCH and the PSSCH. To further minimize the latency of a feedback transmission, e.g., a transmission of a hybrid automatic repeat request (HARQ) acknowledgement (ACK) or a HARQ negative ACK (NACK), and subsequently retransmissions, a transmitting UE may also reserve resources for PSCCH and/or PSSCH for retransmissions.

To further enhance the probability of successful TB decoding based on one sequence of transmissions of the TB (i.e., to reduce the probability to perform retransmissions triggered by feedback), a transmitting UE may repeat the TB transmission along with the initial TB transmission. This mechanism is also referred to as blind retransmission.

When traffic arrives at a transmitting UE, the transmitting UE may (e.g., as a result of the above) select resources for at least one of following transmissions: A transmission of the PSSCH associated with the PSCCH for an initial transmission of the TB, and optionally blind retransmissions of the TB. A transmission of the PSSCH associated with the PSCCH for one or more retransmissions of the TB.

Since each transmitting UE of the SL may autonomously select resources for the SL transmissions, how to prevent different transmitting UEs from selecting the same resources (e.g., radio resources, e.g., time-frequency resources) can be a critical issue in Mode 2. A particular resource selection procedure may be imposed to Mode 2 based on channel sensing. The channel sensing may comprise measuring reference signal received power (RSRP) on different subchannels and/or may require information as to power levels of DM-RS on the PSSCH or DM-RS on the PSCCH of different UEs, e.g., depending on a configuration of these UEs. This information is received at the transmitting UE (e.g., only) by receiving the SCI transmitted by (e.g., all) other UEs.

In any embodiment, the relay UE 100-RL, e.g. an L2 UE-to-Network relay UE, may provide forwarding functionality that can relay any type of traffic over the PC5 interface, i.e. over the SL.

The (e.g., L2 UE-to-Network) relay UE 100-RL provides the functionality to support connectivity to the 5GS for remote UEs 100-RM. A UE 100-RM may be considered to be a remote UE if it has successfully established a PC5 link or SL to a (e.g., L2 UE-to-Network) relay UE 100-RL. A remote UE 100-RM can be located within NG-RAN coverage or outside of NG-RAN coverage.

The relay UE may be a Layer 2 (L2) UE-to-Network relay. The relay UE may be implemented according to the 3GPP document TR 23.752, version 1.0.0, clause 6.7 (e.g., as a L2-based UE-to-Network relay) and/or as is described below. That is, relay UE may comprise a protocol architecture supporting an L2-based UE-to-Network relay (which may also be referred to as L2 UE-to-Network relay or L2 relay UE) is provided.

Any embodiment may implement a user plane stack, e.g., described below.

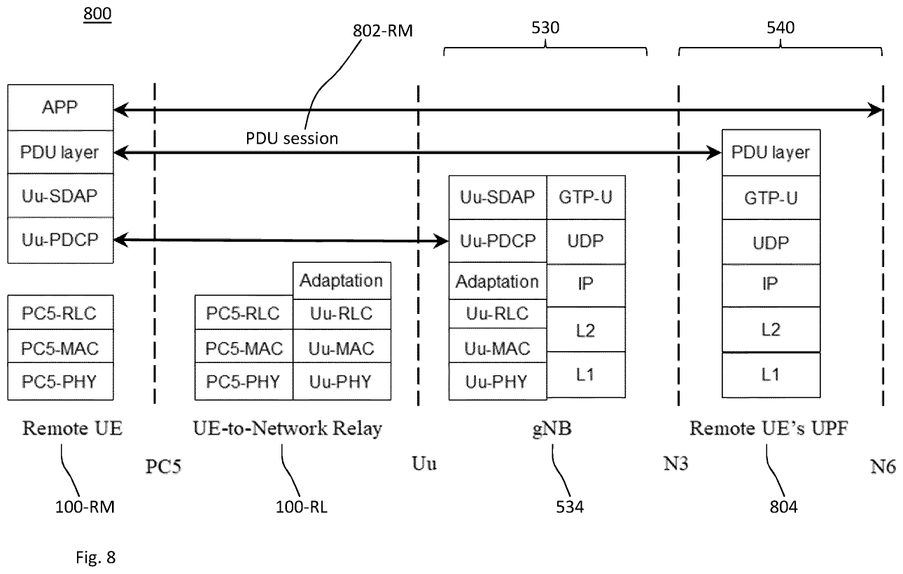

FIG. 8 illustrates the protocol stack for the user plane transport, related to a PDU Session, including a Layer 2 UE-to-Network Relay UE. The PDU layer corresponds to the PDU carried between the Remote UE and the Data Network (DN) over the PDU session. The PDU layer corresponds to the PDU carried between the Remote UE and the Data Network (DN) over the PDU session. It is important to note that the two endpoints of the PDCP link are the Remote UE and the gNB. The relay function is performed below PDCP. This means that data security is ensured between the Remote UE and the gNB without exposing raw data at the UE-to-Network Relay UE.

The PDU session 802-RM of the remote UE 100-RM may extend from the remote UE 100-RM to a user plane function (UPF) 804 of the CN 540.

The methods 300-RM, 300-RL, and/or 301-RL may use a remote UE 100-RM and/or a relay UE 100-RL and/or a gNB 534 in the RAN 530 and/or a User Plane Stack for the L2 UE-to-Network relay UE 100-RL as schematically illustrated in FIG. 8 or Figure A.2.1-1 in 3GPP document TR 23.752, version 1.0.0.

The adaptation rely layer within the UE-to-Network Relay UE can differentiate between signaling radio bearers (SRBs) and data radio bearers (DRBs) for a particular Remote UE. The adaption relay layer is also responsible for mapping PC5 traffic to one or more DRBs of the Uu. The definition of the adaptation relay layer is under the responsibility of RAN WG2.

Any embodiment may implement a control plane stack, e.g., described below.

Each of FIGS. 9A and 9B illustrate an example of the protocol stack of the NAS connection for the remote UE 100-RM and/or the relay UE 100-RL, respectively, to the NAS-MM and NAS-SM components of the CN 540. The NAS messages are transparently transferred between the remote UE 100-RM and 5G-AN over the Layer 2 UE-to-Network relay UE 100-RL using:
PDCP end-to-end connection where the role of the UE-to-Network Relay UE is to relay the PDUs over the signaling radio bear without any modifications.
N2 connection between the 5G-AN and AMF over N2.
N3 connection AMF and SMF over N11.

The role of the UE-to-Network relay UE 100-RL is to relay the PDUs from the signaling radio bearer without any modifications.

As schematically illustrated in FIG. 9A, the RRC connection in the RRC connected state may extent from the remote UE 100-RM to the (serving) gNB 534, e.g., on the RRC layer. The Connection Management (CM) in the CM-connected state of the remote UE 100-RM may extend from the remote UE 100-RM to the AMF 804 of the CN 504, e.g., on the NAS layer.

As schematically illustrated in FIG. 9B, the RRC connection in the RRC connected state of the relay UE 100-RL may extent from the relay UE 100-RL to the (serving) gNB 534, e.g., on the RRC layer. The CM in the CM-connected state of the relay UE 100-RL may extend from the RL UE 100-RL to the AMF 804 of the CN 504, e.g., on the NAS layer.

The methods 300-RM, 300-RL, and/or 301-RL may be performed using the signals and/or protocols illustrated in the FIGS. 9A and 9B, e.g., implemented as an extension of Figure A.2.2-1 on the Control Plane for L2 UE-to-Network Relay UE in 3GPP document TR 23.752, version 1.0.0.

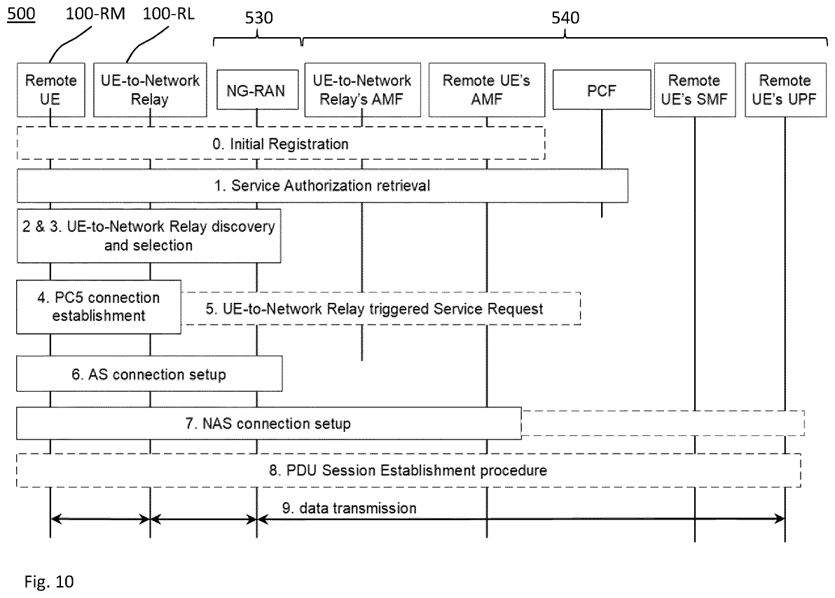

The methods 300-RM, 300-RL, and/or 301-RL may use a connection establishment for indirect communication via the relay UE 100-RL (e.g., a UE-to-Network relay UE 100-RL), optionally as illustrated in FIG. 10 or FIG. 6.7.3-1 in 3GPP document TR 23.752, version 1.0.0.

Alternatively or in addition, the methods 300-RM, 300-RL, and/or 301-RL may comprise at least one of the following Connection Establishment steps.

In a zeroth Connection Establishment step, if in coverage, the remote UE and UE-to-Network Relay UE (briefly: relay UE) may independently perform the initial registration to the network according to registration procedures in the 3GPP document TS 23.502, version 16.7.0. A Global Unique Temporary Identifier (GUTI) allocated to the remote UE (e.g., according to 3GPP 5G NR) is maintained when later non-access stratum (NAS) signaling between remote UE and network (.g., CN 540) is exchanged via the UE-to-Network Relay UE.

For concreteness and not limitation, the description of the embodiments of the methods 300-RM, 300-RL, and/or 301-RL assume a single hop relay.

In a first Connection Establishment step, if in coverage, the remote UE 100-RM and the UE-to-Network relay UE 100-RL independently get the service authorization for indirect communication from the network.

In second and third Connection Establishment steps, the remote UE 100-RM and UE-to-Network relay UE 100-RL perform UE-to-Network Relay UE discovery and selection.

In a fourth Connection Establishment step, the remote UE 100-RM initiates a one-to-one communication connection with the selected UE-to-Network relay UE 100-RL over PC5, by transmitting an indirect communication request message to the UE-to-Network relay 100-RL.

In a fifth Connection Establishment step, if the UE-to-Network relay UE 100-RL is in CM_IDLE state, triggered by the communication request received from the remote UE 100-RM, the UE-to-Network relay UE 100-RL transmits a Service Request message over PC5 to its serving AMF.

The relay UE's AMF may perform authentication of the UE-to-Network Relay UE based on NAS message validation and if needed the AMF will check the subscription data.

If the UE-to-Network Relay UE is already in CM_CONNECTED state and is authorized to perform relay service then the fifth Connection Establishment step may be omitted.

In a sixth Connection Establishment step, the UE-to-Network relay UE 100-RL sends the indirect communication response message to the Remote UE.

In a seventh Connection Establishment step, the remote UE 100-RM transmits a NAS message to the serving AMF. The NAS message is encapsulated in an RRC message that is transmitted over PC5 to the UE-to-Network relay UE 100-RL, and the UE-to-Network relay UE 100-RL forwards the message to the NG-RAN 530. The NG-RAN 530 derives remote UE's serving AMF and forwards the NAS message to this AMF.

For concreteness and without limitation, it is assumed that the Public Land mobile network (PLMN) of the remote UE 100-RM is accessible by the PLMN of the UE-to-Network relay 100-RL (i.e., the relay UE) and/or that the AMF of the relay UE 100-RL supports one or more Network Slices identified by Single-Network Slice Selection Assistance Information (S-NSSAI) the remote UE 100-RM may want to connect to.

If the remote UE 100-RM has not performed the initial registration to the network in zeroth step, the NAS message is an initial registration message. Otherwise, the NAS message is service request message.

If the remote UE 100-RM performs initial registration via the UE-to-Network relay 100-RL (i.e., the relay UE), the serving AMF of the remote UE may perform authentication of the remote UE based on NAS message validation and/or if needed the AMF of the remote UE checks subscription data of the remote UE.

For service request case, User Plane (UP) connection for PDU sessions can also be activated. The other steps may follow clause 4.2.3.2 in the 3GPP document TS 23.502, version 16.7.0.

In an eighth Connection Establishment step, the remote UE 100-RM may trigger establishing a PDU session (i.e., the PDU Session Establishment procedure), e.g., as defined in clause 4.3.2.2 of the 3GPP document TS 23.502, version 16.7.0.

In a nineth Connection Establishment step, the data is transmitted between remote UE 100-RM and user plane function (UPF) 804 via the UE-to-Network relay UE 100-RL (i.e., the relay UE) and the NG-RAN 530. The relay UE 100-RL forwards all the data messages between the remote UE 100-RM and NG-RAN 530 using RAN-specified L2-relay method.

In any embodiment of any of the methods, the mobility update may comprise a registration area update (RAU)

In NR, during the 5G Initial Registration, a UE receives parameters indicating a UE-specific registration area (RA) in the “Registration Accept” message from the AMF, wherein the registration area (RA) is a set of Tracking Areas for the UE. (Herein, “RA” is not an abbreviation for random access.) In this way, a unique RA (e.g., a unique paging area) for the UE can be created.

If the UE moves within its own RA (e.g., its own paging area), the UE does not need to report mobility update to the 5G Core Network (5G CN) 540.

In case the UE moves to a cell outside its current registration area (RA), the UE transmits a “Registration Request” message to the core network (CN) with the Registration Type parameter set to “mobility registration updating”, e.g., for an RA update (RAU).

In addition to the RA, the network (e.g., a 5G system) may comprise a concept of a RAN-based Notification Area (RNA). As described above and/or in clause 9.2.2.3 of the 3GPP document TS 38.300, version 16.4.0, a UE 100 in the RRC_INACTIVE state 502 can be configured by the last serving NG-RAN node 532 with an RNA.

The RNA may comprise or cover a single cell or multiple cells (e.g., one or more contiguous or connected cells). The RNA (i.e., the one or more cells of the RNA) are within, or have to be contained within, the registration area (RA) of the CN 540. Xn connectivity may be (or has to be) available (e.g., for the respective UE) within the RNA (e.g., for 3GPP release 16).

An update of the RNA, i.e., a RAN-based notification area update (RNAU), may be periodically transmitted by the UE. Alternatively or in addition, the RNAU may be transmitted when the UE selects (e.g., when a cell-reselection procedure of the UE selects) a cell that does not belong to the configured RNA (e.g., the current RNA of the UE).

There are several different alternatives on how the RNA can be configured:
List of cells:
   A UE is provided an explicit list of cells (one or more) that constitute the RNA.
List of RAN areas:
   A UE is provided (at least one) RAN area ID, where a RAN area is a subset of a CN Tracking Area or equal to a CN Tracking Area. A RAN area is specified by one RAN area ID, which consists of a TAC and optionally a RAN area Code;
   A cell broadcasts one or more RAN area IDs in the system information.

NG-RAN may provide different RNA definitions to different UEs but not mix different definitions to the same UE at the same time. UE shall support all RNA configuration options listed above.

The embodiments are described in the context of NR, i.e., remote UE and relay UE are deployed in a same or different NR cell. The embodiments are applicable to relay scenarios including UE to network (U2N) relay wherein the link between remote UE and relay UE may be based on LTE sidelink or NR sidelink, the Uu connection between relay UE and base station may be LTE Uu or NR Uu. The connection between remote UE and relay UE is also not limited to a 3GPP sidelink (SL). Any short-range communication technology such as Wi-Fi is equally applicable as the SL.

The embodiments are also applicable to a relay scenario in which the relay UE 100-RL is configured with multiple connections (i.e., the number of connections is equal or larger than two) to the RAN (e.g., dual connectivity and/or carrier aggregation).

The embodiments may be implemented using layer 2 (L2) for the relaying (e.g., adaptation).

When referring to measuring cells, the measurements may relate to measured Uu links and/or cells of a UE (i.e., remote UE or relay UE), e.g. at least one of a camped cell, serving cells, and neighbor cells.

The measured cells may meet one or more of the following conditions. The cells belong to the same or different gNBs, belong to the same or different frequency bands, belong to the same or different Radio Access Technologies (RATs), and/or belong to the same or different Public Land Mobile Networks (PLMNs).

Each of the embodiments may implement at least one the following (e.g., common) first, second and/or third embodiments.

In order to perform mobility procedures, both remote UE and relay UE need to measure Uu links/cells according to measurement configurations provided by the network (e.g., gNB).

In the first embodiment, remote UE 100-RM and the relay UE 100-RL perform measurements on Uu links and/or cells separately.

In the second embodiment, in case both the remote UE and the relay UE may measure the same links (i.e., Uu links/cells). Given that both UEs 100-RM and 100-RL may measure a same cell.

Moreover, since both UEs 100-RM and 100-RL are located in a same proximity area, measurements on the same cell would be similar or equal.

Therefore, it is feasible to reduce or avoid overlapping measurement efforts. It is sufficient to share measurement results on the same links/cells between both UEs. It is beneficial to reduce power consumption for both UEs. For specific links, it is configured/preconfigured to allow only remote UE or relay UE to measure.

After measurements, measurement results are shared between both UEs. The measurement results of a UE are shared to another UE using at least one of the following signaling alternatives: RRC signaling (e.g., PC5-RRC); MAC CE; and Control PDU of a protocol layer such as SDAP, PDCP, RLC, or an adaptation layer.

The measurement results of a cell may contain or relate to at least one of the following: Measurement results in terms of quantities such as RSRP, RSRQ, RSSI, SINR, or SIR etc.; an associated cell ID; an associated RAN area ID; an associated tracking area ID; an associated registration area ID.

Alternatively or in addition, in case multiple remote UEs 100-RM connecting to the same relay UE 100-RL, or a remote UE 100-RM connecting to multiple relay UEs 100-RL, similar mechanisms may be applicable.

In the third embodiment, it is only relay UE that performs measurements on the Uu links. All remote UEs connecting to the same relay UE are configured by the network (e.g., gNB) to not perform measurements on the Uu links. Instead, the relay UE share its measurement results to its remote UEs. The relay UE applies the same options as described in the second embodiments to share its measurement results to remote UEs. The measurement results have the same content as described in the second embodiment.

Any of the following fourth to seventh embodiments may be implemented separately or in combination with the aforementioned embodiments or the embodiments in the list of embodiments.

In the below first group of the fourth to seventh embodiments, the remote UE 100-RM is in RRC_INACTIVE, and the relay UE 100-RL is in RRC_IDLE.

In the fourth embodiment, the remote UE and the relay UE performs the mobility update procedure separately.

In other words, the remote UE reports its RNAU signaling (e.g., RRCResumeRequest or RRCResumeRequest1) to the gNB and its RAU signaling (e.g., registration request message) to the core network (e.g., AMF). While the relay UE reports its RAU signaling (e.g., registration request message) to the core network (e.g., AMF) separately.

In the fifth embodiment, in case the remote UE has triggered a RNAU procedure (i.e., when the remote UE moves to a cell that does not belong to the configured RNA or the remote UE has triggered a periodical RNAU procedure), the remote UE first sends the RNAU signaling (i.e., Uu RRC Resume Request) to the relay UE via the PC5 link. It can be transmitted from the remote UE to the relay UE in a container using the PC5 RRC. After reception of the RNAU signaling, the relay UE may apply at least one of the below options to forward the RNAU signaling to the gNB.

Option 1: initiate a random access procedure (either 2-step random access or 4-step random access) on behalf of the remote UE towards the gNB.

Since the remote UE is in RRC INACTIVE, the relay UE transmits RRCResumeRequest or RRCResumeRequest1 with “rna-Update” as the ResumeCause to the gNB. Alternatively, a new resume cause may be introduced accordingly i.e., RNA update for the remote UE and RACH is performed by the relay UE on behalf of the remote UE. In addition, a remote UE ID (e.g., C-RNTI or I-RNTI or any remote UE IDs known the gNB) is used in the RRCResumeRequest or RRCResumeRequest1.

Upon reception of the RNAU signaling, the gNB handles the remote UE's context as if the remote UE has connected to the gNB directly without via the relay UE (i.e., the gNB acts the procedures as described in clause 2.1.1).

After the above procedure, the remote UE will continuously stay at RRC INACTIVE or go to the other state (e.g., RRC CONNECTED or RRC IDLE) instructed by the gNB.

The relay UE remains at RRC IDLE while performing the above procedure.

Option 2: initiate a random access procedure (either 2-step random access or 4-step random access) for the relay UE itself towards the gNB.

Since the relay UE is in RRC IDLE, the relay UE transmits RRCSetupRequest to the gNB as if the random access procedure has been triggered by itself. In the RRCSetupRequest message, the relay UE selects an existing EstablishmentCause e.g., “mo-Signalling”. Alternatively, a new cause may be introduced accordingly i.e., RNA update for the remote UE. In addition, the RRCSetupRequest message carries the relay UE ID (e.g., ng-5G-S-TMSI or any local ID known to the gNB).

After this RACH procedure has completed, the relay UE goes to RRC CONNECTED state. Thereafter, the relay UE directly sends the RNAU signaling (i.e., RRCResumeRequest or RRCResumeRequest1) to the gNB. Alternatively, the RNAU signaling (i.e., RRCResumeRequest or RRCResumeRequest1) is transmitted as a container in the RRCSetupRequest to the gNB. For either of the two alternatives, the signaling message carries at least one of the following information elements: a remote UE ID (e.g., C-RNTI or I-RNTI); a purpose of the signaling, i.e., RNA update for the remote UE; and at least one other measurement report if it is applicable, e.g., early measurement report, buffer status report, power headroom report, etc.

Upon reception of the RNAU signaling, the RAN 530 (e.g., the serving gNB 534) handles the remote UE's context as if the remote UE has connected to the gNB directly without via the relay UE (e.g., the at last one gNB 532 and 534 of the RAN 530 perform procedures, e.g., as described for the FIGS. 5 to 7 above).

After transmission of the RNAU signaling, the relay UE may switch to RRC INACTIVE or RRC IDLE instructed by the gNB. In order to assist a decision of the gNB, the relay UE 100-RL may provide additional information including at least one of the following indicators. A first indicator is indicative of whether the relay UE has more data or signaling for further transmissions. A second indicator is indicative of whether the relay UE prefers to stay at RRC CONNECTED or go to other RRC state such as RRC IDLE or RRC_INACTIVE.

After the above procedure, the remote UE 100-RM may continuously stay at RRC INACTIVE or go to the other state (e.g., RRC CONNECTED or RRC IDLE), e.g. as instructed by the RAN (e.g., a gNB).

In the sixth embodiment, in case the remote UE has triggered a RAU procedure (i.e., when the remote UE moves out its registration area or the remote UE has triggered a periodical RAU procedure), the remote UE first sends the RAU signaling (i.e., NAS registration request) to the relay UE via the PC5 link. It can be transmitted from the remote UE to the relay UE in a container using the PC5 RRC. After reception of the RAU signaling, the relay UE may apply the same options as described in the fifth embodiments to forward the RAU signaling to the gNB.

Alternatively, the relay UE will wait until itself has also triggered a RAU procedure and sends a combined RAU signaling which carries both the remote UE ID and the relay UE ID to the gNB. The gNB will further send the signaling to the core network (e.g., AMF). If the AMF serving the relay UE is different from the AMF serving the remote UE, then the AMF (relay) should forward the RAU message to the AMF (remote). If the AMF (relay) and AMF (remote) are the same, and AMF knows the association between the relay and remote UE, then remote UE ID in the RAU signaling can be skipped.

In the seventh embodiment, the remote UE is configured to trigger neither RNAU nor RAU by itself. Both procedures will be handled by the relay UE representing the remote UE. The relay UE applies the same options as described in the above embodiments to forward the RNAU or RAU signaling to the gNB on behalf of the remote UE. In this case, the relay UE needs to store remote UE's configuration/information on configured RAN notification areas (RNAs), and/or registration area. Although the relay UE is in RRC IDLE, the relay UE will check periodically whether the remote UE has triggered RNAU or RAU. Whenever a procedure is triggered for the remote UE, the relay UE may indicate to the remote UE via at least one of the below signaling alternatives: PC5-RRC; MAC CE; a control PDU of a protocol layer (e.g., SDAP, PDCP, or RLC); and L1 signaling (e.g., SCI in PSCCH, or PSSCH, or an indicator in PSFCH).

Alternatively, there is only one of the two procedures (e.g., RAU) is handled by the relay UE, while the other procedure (e.g., RNAU) is handled by the remote UE itself.

Any of the following eighth to eleventh embodiments may be implemented separately or in combination with the aforementioned embodiments or the embodiments in the list of embodiments.

In the below second group of eighth to eleventh embodiments, the remote UE 100-RM is in RRC_IDLE, and the relay UE 100-RL is in RRC_INACTIVE.

In the eighth embodiment, the remote UE and the relay UEs perform the mobility update procedure separately.

In other words, the remote UE reports its RAU signaling (e.g., NAS registration request message) to the core network (e.g., AMF). While the relay UE reports its RNAU signaling (e.g., RRCResumeRequest or RRCResumeRequest1) to the gNB and its RAU signaling (e.g., registration request message) to the core network (e.g., AMF) separately.

In the ninth embodiment, in case the remote UE has triggered a RAU procedure (i.e., when the remote UE moves out its registration area or the remote UE has triggered a periodical RAU procedure), the remote UE first sends the RAU signaling (i.e., NAS registration request) to the relay UE via the PC5 link. It can be transmitted from the remote UE to the relay UE in a container using the PC5 RRC.

After reception of the RAU signaling, the relay UE may apply at least one of the below options to forward the RAU signaling to the gNB.

Option 1: initiate a random access procedure (either 2-step random access or 4-step random access) on behalf of the remote UE towards the gNB.

Since the remote UE is in RRC IDLE, the relay UE transmits RRCSetupRequest to the gNB on behalf of the remote UE. In the RRCSetupRequest message, the relay UE selects an existing EstablishmentCause e.g., “mo-Signaling”. Alternatively, a new cause may be introduced accordingly i.e., registration area update (RAU) for the remote UE. In addition, the RRCSetupRequest message carries the remote UE ID (e.g., ng-5G-S-TMSI or any local ID known to the gNB).

In addition, the RAU signaling (i.e., NAS registration request) is included in the dedicatedNAS-Message field in RRCSetupRequest or RRCSetupComplete message.

Upon reception of the RAU signaling, the gNB forwards the message to the core network (i.e., AMF).

After the above procedure, the remote UE 100-RM may go to RRC_CONNECTED or go to the other state (e.g., RRC_IDLE or RRC_INACTIVE), e.g., as instructed by the RAN (e.g., the gNB).

The relay UE 100-RL may remain at RRC_INACTIVE while performing the above procedure.

Option 2: initiate a random access procedure (either 2-step random access or 4-step random access) for the relay UE itself towards the gNB as if the relay UE has triggered the random access procedure by itself.

Since the relay UE is in RRC INACTIVE, the relay UE transmits RRCResumeRequest or RRCResumeRequest1 with an existing ResumeCause e.g., “mo-signaling” to the gNB. Alternatively, a new resume cause may be introduced accordingly i.e., RA update (RAU) for the remote UE.

In addition, the message carries the relay UE ID (e.g., C-RNTI or I-RNTI).

After this RACH procedure has completed, the relay UE goes to RRC CONNECTED state. Thereafter, the relay UE directly sends the RAU signaling (i.e., NAS registration request) to the gNB. Alternatively, the RAU signaling is included in the dedicatedNAS-Message field in the RRCResumeRequest or RRCResumeRequest1 to the gNB. For either of the two alternatives, the signaling message carries at least one of the below information elements: a remote UE ID (e.g., 5G-S-TMSI or any local ID known to the gNB); and a purpose of the signaling, i.e., RA update (RAU) for the remote UE.

After transmission of the RAU signaling for the remote UE, the relay UE may switch to RRC CONNECTED or RRC IDLE instructed by the gNB. In order to assist the gNB's decision, the relay UE 100-RL may provide additional information including one of the below indicators. A first indicator is indicative of whether the relay UE has more data or signaling for further transmissions. A second indicator is indicative of whether the relay UE prefers to stay at RRC CONNECTED or go to other RRC state such as RRC IDLE or RRC INACTIVE.

After the above procedure, the remote UE 100-RM may continuously stay at RRC_IDLE or go to the other state (e.g., RRC_CONNECTED or RRC_INACTIVE), e.g., as instructed by the RAN (e.g., the gNB).

In the tenth embodiment, in case the remote UE has triggered a RAU procedure (i.e., when the remote UE moves out its registration area or the remote UE has triggered a periodical RAU procedure), the remote UE first sends the RAU signaling (i.e., NAS registration request) to the relay UE via the PC5 link. It can be transmitted from the remote UE to the relay UE in a container using the PC5 RRC.

After reception of the RAU signaling, the relay UE may wait until itself has also triggered a RAU procedure and sends a combined RAU signaling which carries both the remote UE ID and the relay UE ID to the gNB. The gNB will further send the signaling to the core network (e.g., AMF). If the AMF serving the relay UE is different from the AMF serving the remote UE, then the AMF(relay) should forward the RAU message to the AMF (remote). If the AMF (relay) and AMF (remote) are the same, and AMF knows the association between the relay and remote UE, then remote UE ID in the RAU signaling can be skipped.

In the eleventh embodiment, the remote UE is configured to not trigger RAU by itself. The procedure will be handled by the relay UE on behalf of the remote UE. The relay UE applies the same options as described in the ninth embodiment to forward the RAU signaling to the gNB on behalf of the remote UE. In this case, the relay UE needs to store remote UE's configuration/information on the registration area. The relay UE will check periodically whether the remote UE has triggered RAU. Whenever a procedure is triggered for the remote UE, the relay UE may indicate to the remote UE via at least one of the below signaling alternatives: PC5-RRC; MAC CE; a control PDU of a protocol layer (e.g., SDAP, PDCP, or RLC); and L1 signaling (e.g., SCI in PSCCH, or PSSCH, or an indicator in PSFCH).

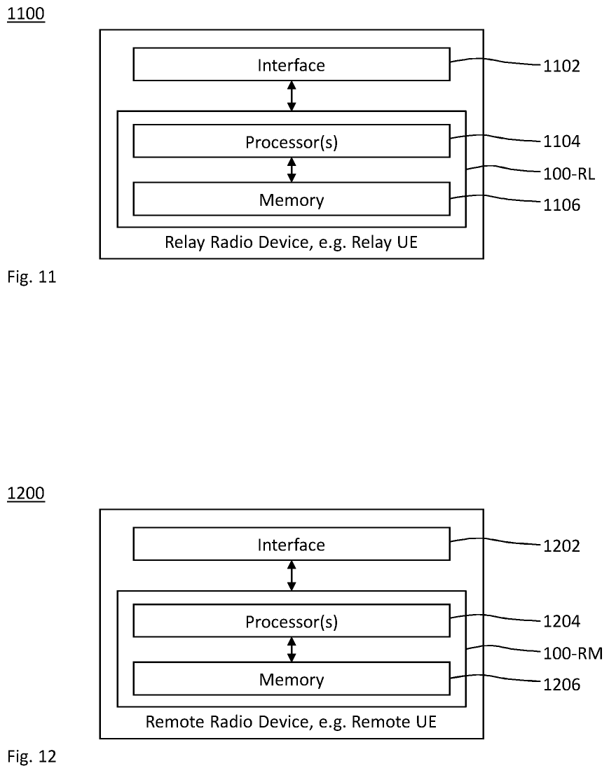

FIG. 11 shows a schematic block diagram for an embodiment of the device 100-RL. The device 100 comprises processing circuitry, e.g., one or more processors 1104 for performing the method 300-RL and memory 1106 coupled to the processors 1104. For example, the memory 1106 may be encoded with instructions that implement at least one of the modules 102-RL and 104-RL.

The one or more processors 1104 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1106, relay functionality (e.g., L2 relay functions). For example, the one or more processors 1104 may execute instructions stored in the memory 1106. Such functionality may include providing various features and steps discussed herein, including any of the benefits disclosed herein. The expression “the device being operative to perform an action” may denote the device 100 being configured to perform the action.

As schematically illustrated in FIG. 11, the device 100-RM may be embodied by a relay radio device 1100, e.g., functioning as a relay UE. The relay UE 1100 comprises a radio interface 1102 coupled to the device 100-RL for radio communication with one or more remote UEs and/or base stations.

FIG. 12 shows a schematic block diagram for an embodiment of the device 100-RM. The device 100-RM comprises processing circuitry, e.g., one or more processors 1204 for performing the method 300-RM and memory 1206 coupled to the processors 1204. For example, the memory 1206 may be encoded with instructions that implement at least one of the modules 102-RM and 204-RM.

The one or more processors 1204 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 1206, UE functionality. For example, the one or more processors 1204 may execute instructions stored in the memory 1206. Such functionality may include providing various features and steps discussed herein, including any of the benefits disclosed herein. The expression “the device being operative to perform an action” may denote the device 200 being configured to perform the action.

As schematically illustrated in FIG. 12, the device 100-RM may be embodied by a remote radio device 1200, e.g., functioning as a remote UE. The remote UE 1200 comprises a radio interface 1202 coupled to the device 100-RM for radio communication with one or more relay UEs and/or base stations.

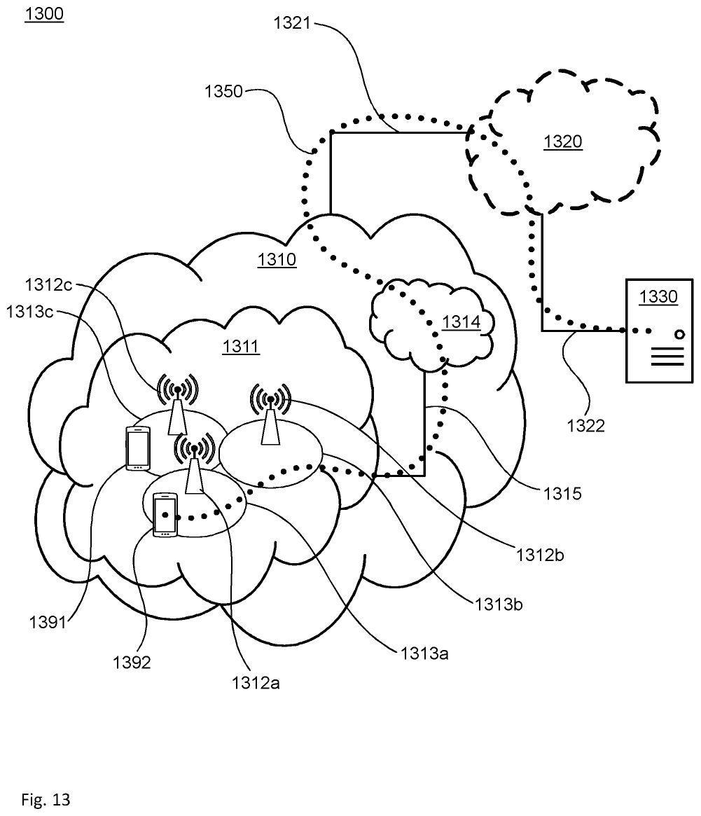

With reference to FIG. 13, in accordance with an embodiment, a communication system 1300 includes a telecommunication network 1310, such as a 3GPP-type cellular network, which comprises an access network 1311, such as a radio access network, and a core network 1314. The access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to the core network 1314 over a wired or wireless connection 1315. A first user equipment (UE) 1391 located in coverage area 1313c is configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312.

Any of the base stations 1312 and the UEs 1391, 1392 may embody the device 100.

The telecommunication network 1310 is itself connected to a host computer 1330, which may be embodied in the hardware and/or software of a standalone server, a cloud-implemented server, a distributed server or as processing resources in a server farm. The host computer 1330 may be under the ownership or control of a service provider, or may be operated by the service provider or on behalf of the service provider. The connections 1321, 1322 between the telecommunication network 1310 and the host computer 1330 may extend directly from the core network 1314 to the host computer 1330 or may go via an optional intermediate network 1320. The intermediate network 1320 may be one of, or a combination of more than one of, a public, private or hosted network; the intermediate network 1320, if any, may be a backbone network or the Internet; in particular, the intermediate network 1320 may comprise two or more sub-networks (not shown).

The communication system 1300 of FIG. 13 as a whole enables connectivity between one of the connected UEs 1391, 1392 and the host computer 1330. The connectivity may be described as an over-the-top (OTT) connection 1350. The host computer 1330 and the connected UEs 1391, 1392 are configured to communicate data and/or signaling via the OTT connection 1350, using the access network 1311, the core network 1314, any intermediate network 1320 and possible further infrastructure (not shown) as intermediaries. The OTT connection 1350 may be transparent in the sense that the participating communication devices through which the OTT connection 1350 passes are unaware of routing of uplink and downlink communications. For example, a base station 1312 need not be informed about the past routing of an incoming downlink communication with data originating from a host computer 1330 to be forwarded (e.g., handed over) to a connected UE 1391. Similarly, the base station 1312 need not be aware of the future routing of an outgoing uplink communication originating from the UE 1391 towards the host computer 1330.

By virtue of at least one of the methods 300-RL, 300-RM, and 301-RL being performed by any one of the UEs 1391 or 1392 and/or accordingly by any one of the base stations 1312, the performance or range of the OTT connection 1350 can be improved, e.g., in terms of increased throughput, reduced latency and/or power consumption. More specifically, the host computer 1330 may indicate to the RAN 530 or the relay radio device 100-RL or the remote radio device 100-RM (e.g., on an application layer) when to assume the first and second RRC states, respectively.

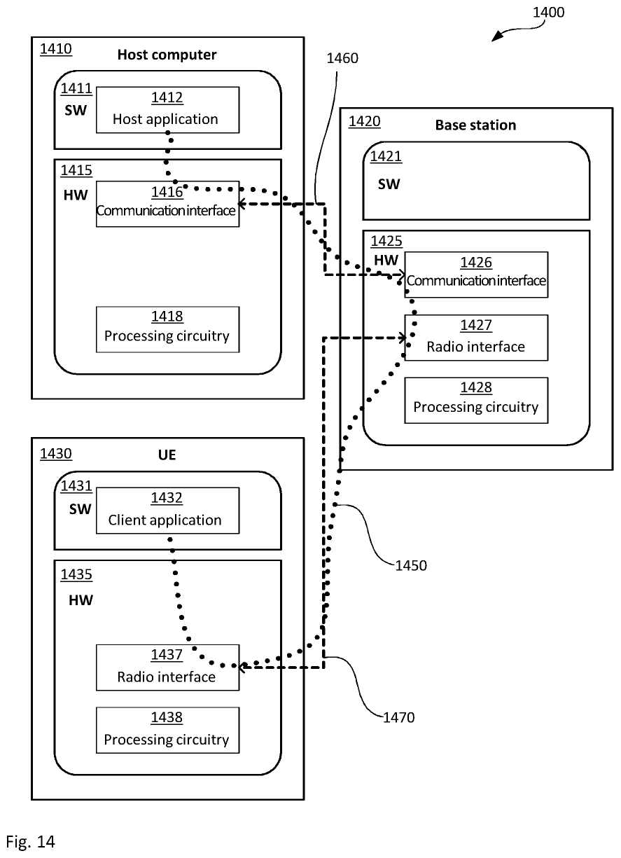

Example implementations, in accordance with an embodiment of the UE, base station and host computer discussed in the preceding paragraphs, will now be described with reference to FIG. 14. In a communication system 1400, a host computer 1410 comprises hardware 1415 including a communication interface 1416 configured to set up and maintain a wired or wireless connection with an interface of a different communication device of the communication system 1400. The host computer 1410 further comprises processing circuitry 1418, which may have storage and/or processing capabilities. In particular, the processing circuitry 1418 may comprise one or more programmable processors, application-specific integrated circuits, field programmable gate arrays or combinations of these (not shown) adapted to execute instructions. The host computer 1410 further comprises software 1411, which is stored in or accessible by the host computer 1410 and executable by the processing circuitry 1418. The software 1411 includes a host application 1412. The host application 1412 may be operable to provide a service to a remote user, such as a UE 1430 connecting via an OTT connection 1450 terminating at the UE 1430 and the host computer 1410. In providing the service to the remote user, the host application 1412 may provide user data, which is transmitted using the OTT connection 1450. The user data may depend on the location of the UE 1430. The user data may comprise auxiliary information or precision advertisements (also: ads) delivered to the UE 1430. The location may be reported by the UE 1430 to the host computer, e.g., using the OTT connection 1450, and/or by the base station 1420, e.g., using a connection 1460.

The communication system 1400 further includes a base station 1420 provided in a telecommunication system and comprising hardware 1425 enabling it to communicate with the host computer 1410 and with the UE 1430. The hardware 1425 may include a communication interface 1426 for setting up and maintaining a wired or wireless connection with an interface of a different communication device of the communication system 1400, as well as a radio interface 1427 for setting up and maintaining at least a wireless connection 1470 with a UE 1430 located in a coverage area (not shown in FIG. 14) served by the base station 1420. The communication interface 1426 may be configured to facilitate a connection 1460 to the host computer 1410. The connection 1460 may be direct, or it may pass through a core network (not shown in FIG. 14) of the telecommunication system and/or through one or more intermediate networks outside the telecommunication system. In the embodiment shown, the hardware 1425 of the base station 1420 further includes processing circuitry 1428, which may comprise one or more programmable processors, application-specific integrated circuits, field programmable gate arrays or combinations of these (not shown) adapted to execute instructions. The base station 1420 further has software 1421 stored internally or accessible via an external connection.

The communication system 1400 further includes the UE 1430 already referred to. Its hardware 1435 may include a radio interface 1437 configured to set up and maintain a wireless connection 1470 with a base station serving a coverage area in which the UE 1430 is currently located. The hardware 1435 of the UE 1430 further includes processing circuitry 1438, which may comprise one or more programmable processors, application-specific integrated circuits, field programmable gate arrays or combinations of these (not shown) adapted to execute instructions. The UE 1430 further comprises software 1431, which is stored in or accessible by the UE 1430 and executable by the processing circuitry 1438. The software 1431 includes a client application 1432. The client application 1432 may be operable to provide a service to a human or non-human user via the UE 1430, with the support of the host computer 1410. In the host computer 1410, an executing host application 1412 may communicate with the executing client application 1432 via the OTT connection 1450 terminating at the UE 1430 and the host computer 1410. In providing the service to the user, the client application 1432 may receive request data from the host application 1412 and provide user data in response to the request data. The OTT connection 1450 may transfer both the request data and the user data. The client application 1432 may interact with the user to generate the user data that it provides.

It is noted that the host computer 1410, base station 1420 and UE 1430 illustrated in FIG. 14 may be identical to the host computer 1330, one of the base stations 1312a, 1312b, 1312c and one of the UEs 1391, 1392 of FIG. 13, respectively. This is to say, the inner workings of these entities may be as shown in FIG. 14, and, independently, the surrounding network topology may be that of FIG. 13.

In FIG. 14, the OTT connection 1450 has been drawn abstractly to illustrate the communication between the host computer 1410 and the UE 1430 via the base station 1420, without explicit reference to any intermediary devices and the precise routing of messages via these devices. Network infrastructure may determine the routing, which it may be configured to hide from the UE 1430 or from the service provider operating the host computer 1410, or both. While the OTT connection 1450 is active, the network infrastructure may further take decisions by which it dynamically changes the routing (e.g., on the basis of load balancing consideration or reconfiguration of the network).

The wireless connection 1470 between the UE 1430 and the base station 1420 is in accordance with the teachings of the embodiments described throughout this disclosure. One or more of the various embodiments improve the performance of OTT services provided to the UE 1430 using the OTT connection 1450, in which the wireless connection 1470 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1450 between the host computer 1410 and UE 1430, in response to variations in the measurement results. The measurement procedure and/or the network functionality for reconfiguring the OTT connection 1450 may be implemented in the software 1411 of the host computer 1410 or in the software 1431 of the UE 1430, or both. In embodiments, sensors (not shown) may be deployed in or in association with communication devices through which the OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of the OTT connection 1450 may include message format, retransmission settings, preferred routing etc.; the reconfiguring need not affect the base station 1420, and it may be unknown or imperceptible to the base station 1420. Such procedures and functionalities may be known and practiced in the art. In certain embodiments, measurements may involve proprietary UE signaling facilitating the host computer's 1410 measurements of throughput, propagation times, latency and the like. The measurements may be implemented in that the software 1411, 1431 causes messages to be transmitted, in particular empty or “dummy” messages, using the OTT connection 1450 while it monitors propagation times, errors etc.

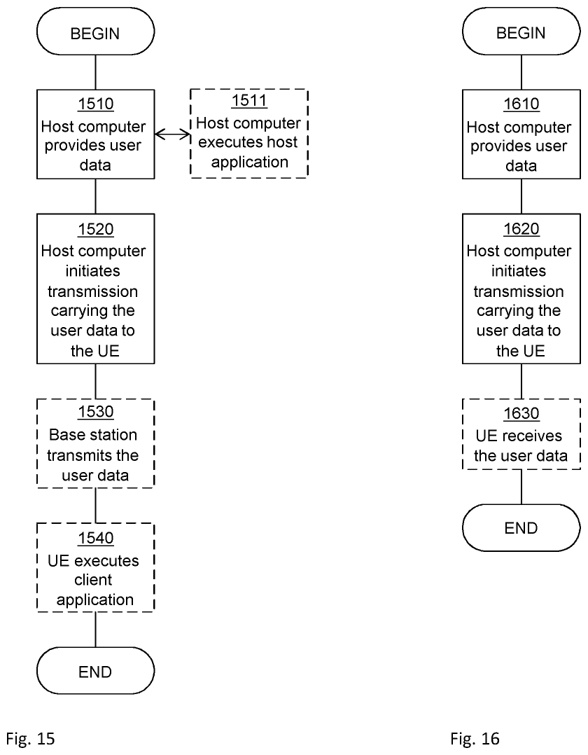

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this paragraph. In a first step 1510 of the method, the host computer provides user data. In an optional substep 1511 of the first step 1510, the host computer provides the user data by executing a host application. In a second step 1520, the host computer initiates a transmission carrying the user data to the UE. In an optional third step 1530, the base station transmits to the UE the user data which was carried in the transmission that the host computer initiated, in accordance with the teachings of the embodiments described throughout this disclosure. In an optional fourth step 1540, the UE executes a client application associated with the host application executed by the host computer.

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this paragraph. In a first step 1610 of the method, the host computer provides user data. In an optional substep (not shown) the host computer provides the user data by executing a host application. In a second step 1620, the host computer initiates a transmission carrying the user data to the UE. The transmission may pass via the base station, in accordance with the teachings of the embodiments described throughout this disclosure. In an optional third step 1630, the UE receives the user data carried in the transmission.

As has become apparent from above description, at least some embodiments of the technique can enable a remote UE to transmit mobility update signaling (i.e., a mobility update report such as a RAN notification area update and/or registration area update) to the RAN (e.g., a gNB) via a relay UE on time and/or when in different RRC states.

Same or further embodiments can reduce unnecessary measurement efforts, e.g., by sharing (i.e., exchanging) a result of the measurement using the SL.

Same or further embodiments may reduce signaling overhead by the relay UE transmitting a combined report message for both relay and remote UE to the RAN (e.g., a gNB).

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following list of claims.

1-61. (canceled)

62. A method performed by a relay radio device, the method comprising:
determining a mobility update report on behalf of a remote radio device based on a result of a measurement of at least one cell, wherein:
the remote radio device is in relayed radio communication with a radio access network (RAN) through the relay radio device;
the remote radio device is in a first radio resource control (RRC) state relative to the RAN that is different from a second RRC state of the relay radio device relative to the RAN;
the result of the measurement is shared on a sidelink between the remote radio device and the relay radio device; and
the mobility update report is indicative of a mobility update of the remote radio device; and
transmitting the mobility update report to the RAN.

63. The method of claim 62, wherein the mobility update of the remote radio device is triggered by measuring at least one of a camped cell of the remote radio device, one or more serving cells of the remote radio device, one or more neighbor cells of the remote radio device, a camped cell of the relay radio device, one or more serving cells of the relay radio device, and one or more neighbor cells of the relay radio device.

64. The method of claim 62, wherein:
the first RRC state is not an RRC connected state; and/or
the second RRC state is not an RRC connected state; and/or
the transmitting of the mobility update report to the RAN comprises initiating a random access procedure with the RAN.

65. The method of claim 62, wherein the mobility update report is triggered by the remote radio device moving out of a first area, wherein a size of the first area and/or a spatial granularity of the mobility update depends on the first RRC state.

66. The method of claim 62, wherein the remote radio device and the relay radio device perform a procedure of the mobility update separately.

67. The method of claim 62, wherein the first RRC state is an RRC inactive state and the second RRC state is an RRC idle state.

68. The method of claim 62, wherein the mobility update report is triggered by the remote radio device moving out of a RAN-based notification area (RNA).

69. The method of claim 62, wherein the mobility update comprises a RAN-based notification area update (RNAU).

70. The method of claim 62, wherein the mobility update report comprises an RRC resume request.

71. The method of claim 62, wherein transmitting the mobility update report to the RAN comprises initiating a random access procedure on behalf of the remote radio device towards the RAN.

72. A relay radio device, the method comprising:
processing circuitry and memory, the memory containing instructions executable by the processing circuitry whereby the relay radio device is configured to:
determine a mobility update report on behalf of a remote radio device based on a result of a measurement of at least one cell, wherein:
the remote radio device is in relayed radio communication with a radio access network (RAN) through the relay radio device;
the remote radio device is in a first radio resource control (RRC) state relative to the RAN that is different from a second RRC state of the relay radio device relative to the RAN;
the result of the measurement is shared on a sidelink between the remote radio device and the relay radio device; and
the mobility update report is indicative of a mobility update of the remote radio device; and
transmit the mobility update report to the RAN.

73. The relay radio device of claim 72, wherein the mobility update of the remote radio device is triggered by measuring at least one of a camped cell of the remote radio device, one or more serving cells of the remote radio device, one or more neighbor cells of the remote radio device, a camped cell of the relay radio device, one or more serving cells of the relay radio device, and one or more neighbor cells of the relay radio device.

74. The relay radio device of claim 72, wherein:
the first RRC state is not an RRC connected state; and/or
the second RRC state is not an RRC connected state; and/or
the transmitting of the mobility update report to the RAN comprises initiating a random access procedure with the RAN.

75. The relay radio device of claim 72, wherein the mobility update report is triggered by the remote radio device moving out of a first area, wherein a size of the first area and/or a spatial granularity of the mobility update depends on the first RRC state.

76. The relay radio device of claim 72, wherein the remote radio device and the relay radio device perform a procedure of the mobility update separately.

77. The relay radio device of claim 72, wherein the first RRC state is an RRC inactive state and the second RRC state is an RRC idle state.

78. The relay radio device of claim 72, wherein the mobility update report is triggered by the remote radio device moving out of a RAN-based notification area (RNA).

79. The relay radio device of claim 72, wherein the mobility update comprises a RAN-based notification area update (RNAU).

80. A method performed by a system comprising a relay radio device and a remote radio device, the method comprising:
transmitting, by the remote radio device on a sidelink between the remote radio device and the relay radio device, a result of a measurement of at least one cell, wherein:
the remote radio device is in relayed radio communication with a radio access network (RAN) through the relay radio device; and
the remote radio device is in a first radio resource control RRC state relative to the RAN that is different from a second RRC state of the relay radio device relative to the RAN;
determining, by the relay radio device, a mobility update report on behalf of the remote radio device based on the result of a measurement of at least one cell, wherein the mobility update report is indicative of a mobility update of the remote radio device;
transmitting, by the relay radio device, the mobility update report to the RAN.

81. A system comprising:
a remote radio device in relayed radio communication with a radio access network (RAN) through a relay radio device, wherein:
the remote radio device is configured to transmit, on a sidelink between the remote radio device and a relay radio device, a result of a measurement of at least one cell; and
the remote radio device is in a first radio resource control RRC state relative to the RAN that is different from a second RRC state of the relay radio device relative to the RAN;
the relay radio device, wherein the relay radio device is configured to:
determine a mobility update report on behalf of the remote radio device based on the result of a measurement of at least one cell, wherein the mobility update report is indicative of a mobility update of the remote radio device; and
transmit the mobility update report to the RAN.
